(19) United States
(12) Patent Application Publication
(10) Pub. No.: US 2026/0071533 A1
(43) Pub. Date: Mar. 12, 2026

(54) TREATMENT FLUID SELECTION

(71) Applicant: Halliburton Energy Services, Inc., Houston, TX (US)

(72) Inventors: Chaitanya Mallikarajun Karale, Houston, TX (US); Dinesh Ananda Shetty, Houston, TX (US)

(73) Assignee: Halliburton Energy Services, Inc., Houston, TX (US)

(21) Appl. No.: 18/826,569

(22) Filed: Sep. 6, 2024

(51) Int. Cl. E21B 44/00; C09K 8/74; E21B 43/27

(52) U.S. Cl. CPC E21B 44/00; C09K 8/74; E21B 43/27; C09K 2208/30; C09K 2208/32

(57) ABSTRACT

Methods for treating a subterranean formation with a treatment fluid comprise introducing the treatment fluid into a wellbore extending into a subterranean formation, measuring a surface treating pressure, changing a concentration of the friction reducer to have at least two surface treating pressure measurements within a surface treating pressure range, establishing a relationship between the surface treating pressure measurements and the concentrations of the friction reducer, evaluating a friction reducer efficiency, and selecting the friction reducer with the best efficiency for a next stage of a multistage fracturing job. The treatment fluid includes water, an acid, a corrosion inhibitor, and a friction reducer.

### BACKGROUND

During the drilling, completion, and stimulation of subterranean wells, treatment fluids and crude oil are pumped through wellbores and tubular structures (e.g., pipes, coiled tubing, flowlines, surface pipelines, etc.). A considerable amount of energy may be lost to friction during pumping of these fluids. For example, the fluids may become turbulent or form eddy currents when flowing through wellbore casing or other conduits. As a result of these energy losses, additional horsepower may be needed to achieve the desired treatment. To reduce these energy losses treatment fluids may be added to wellbore fluids. Treatment fluids, such as friction-reducers, are chemical additives that alter fluid rheological properties to reduce friction created within a fluid as it flows through tubulars or other flow paths.

### BRIEF DESCRIPTION OF THE DRAWINGS

These drawings illustrate certain aspects of some of the embodiments of the present disclosure and should not be used to limit or define the method.

FIG. 1 illustrates surface equipment for delivering a treatment fluid to a wellbore in accordance with embodiments of the present disclosure;

FIG. 2 illustrates a wellbore treatment configuration for performing a coiled tubing operation in accordance with embodiments of the present disclosure;

FIG. 3 illustrates a wellbore treatment configuration for fracturing a subterranean formation in accordance with embodiments of the present disclosure;

FIG. 4 illustrates an example information handling system in accordance with embodiments of the present disclosure;

FIG. 5 illustrates an example information handling system 114 having a chipset architecture that may be used in executing the described method in accordance with embodiments of the present disclosure;

FIG. 6 illustrates an example of one arrangement of resources in a computing network that may employ the processes and techniques in accordance with embodiments of the present disclosure;

FIG. 7 illustrates a neural network that may be utilized to determine efficiency of treatment fluid within the wellbore in accordance with embodiments of the present disclosure;

FIG. 8 illustrates a workflow for selecting a treatment fluid to be used in a downhole operation in accordance with embodiments of the present disclosure;

FIG. 9 is an example of the calibration stage in accordance with embodiments of the present disclosure

FIG. 10 is an example of the surface treating pressure as a function of the concentration of friction reducer in accordance with embodiments of the present disclosure;

FIG. 11 illustrates the surface treating pressure per unit length of treatment interval from surface as a function of concentration of friction reducer for different measured depths in accordance with embodiments of the present disclosure; and

FIG. 12 illustrates the fluid efficiency metric as a function of measured depth in accordance with embodiments of the present disclosure.

### DETAILED DESCRIPTION

Disclosed herein are treatment fluids and methods of surface treating a subterranean formation and, more particularly, disclosed are methods for treating a subterranean formation with a treatment fluid. In a multistage fracturing job for example, the surface treating pressure is recorded as the concentration of treatment fluid, such as a friction reducer, is changed in the first stage, or calibration stage. This relationship of surface treating pressure as a function of concentration of treatment fluid reducer is then used to fit a mathematical model and evaluate a performance evaluation metric, or treatment fluid performance metric, which is the maximum change in surface treating pressure per unit of length for a specified change of concentration of the treatment fluid. It should be noted that this performance evaluation metric is a generic metric independent of the formation and reservoir conditions from which the data was acquired.

The treatment fluid performance metric calculated from the data acquired in the calibration stage is then compared to other treatment fluid performance metrics compiled in a database using the operating conditions of the respective stage or treatment of the multistage fracturing job including water quality used in the treatment fluid, concentration of proppant, pumping rate, downhole pressure and temperature, and inside diameter of the tubing, for example. The treatment fluid performance metrics are then ordered by treatment fluid efficiency for the next stage operating conditions. The method is evolutionary as it allows for re-calibration as fracturing stages are completed towards heel to account for treatment fluid stability in a data driven model. The data driven model may allow the treatment fluid concentration or component to be changed in real-time as the operating conditions changes from one stage or treatment to another stage or treatment including depth (i.e., temperature, pressure) and shear the treatment fluid may be submitted to. The real-time analysis of the treatment fluid efficiency metric allows optimization of the type of treatment fluid, concentration, ratio of different fluids if mixed on surface if chosen, water quality, pumping rate, and proppant concentration as a function of the operating conditions including downhole pressure and temperature, and inside diameter of the tubing, for example.

There are many advantages to the methods and compositions as presently disclosed, only some of which are discussed or alluded to herein. In one or more examples, fracturing or other wellbore operations involving treatment fluids may be performed while reducing a total amount of head loss and/or an energy requirement of the operations. For example, flow rates of these treatment fluids may be higher than what can normally be achieved using conventional treatment fluids. Other advantages may include good compatibility between friction reducers and corrosion inhibitors, as well as good polymer elongation. Other examples may include an improved ability to pump above a fracture gradient, improved fracture extension, overcoming of conventional pumping pressure limitations, higher pumping rates than those maximally achievable with presently used viscosifying agents.

Treatment fluids of the present disclosure may be used during hydrocarbon resource recovery. The treatment fluids may also be used with other forms of energy carriers, such as in geothermal fluids. The treatment fluids may also be used during cleaning of surface pipelines, such as pipelines used for transporting hydrocarbon resources across great distances. Surface pipelines may or may not be connected to a wellbore. The treatment fluids may be used in injector wells. In addition, the treatment fluids may be used in wellbore cleanout, coiled tubing procedures, filter cake removal, scale removal, damage removal, hydrate treatment, hydrate inhibition, and open hole diversion, frac-pac clean out, gravel pack clean out, re-fracturing or re-stimulation of previously fractured well, to use non-limiting examples. In general, the treatment fluids generally comprise water, an acid, a corrosion inhibitor, and a friction reducer. In addition to these, various other chemicals or additives may be optionally included in the treatment fluids, as disclosed herein.

Treatment fluids of the present disclosure may be aqueous and/or non-emulsified, having a single aqueous continuous phase. For example, water may be present in a treatment fluid in an amount greater than 60 wt. %, such as from about 60 wt. % to about 99.9 wt. %. Alternatively, from about 60 wt. % to about 75 wt. %, about 75 wt. % to about 85 wt. %, about 85 wt. % to about 95 wt. %, about 95 wt. % to about 99.9 wt. %, or any ranges therebetween. Alternatively, treatment fluids of the present disclosure may, in some examples, be nonaqueous and/or emulsified. The treatment fluids may be used in direct emulsions or invert emulsions. A water-in-oil emulsion may be used, for example, where the treatment fluid comprises a water phase comprising an active acid concentration of 7 wt. % to 28 wt. % HCl and an oleaginous phase. An oleaginous phase may comprise a refined or distillation product such as diesel, xylene, blended or mixed hydrocarbons, naphtha, alkenes, high order ethylenics or olefins, butadiene, isoparaffins, oleic acids, limonene, squalene, and any combination thereof.

As used herein, aqueous fluids may generally include water and, optionally, one or more species dissolved or suspended therein. Water used in a treatment fluid may be derived from any suitable source, and may comprise fresh water, saltwater (e.g., water containing one or more salts dissolved therein like sodium chloride, calcium chloride, potassium chloride, magnesium chloride, soluble sulfate salts, and calcium nitrate, brine, seawater, treated seawater, field water, stream water, groundwater, industrially treated or brackish water, the like, and/or any combination thereof.

The fluids described herein may comprise, without limitation, aqueous fluids, wellbore fluids, reservoir fluids, brines, fresh water, salt water, water from any source, wellbore treatment fluids, production fluids, injection fluids, hydraulic fracturing fluid, enhanced oil recovery fluids, SAGD well fluids, fracturing fluids, proppants, cementing fluids, spacer fluids, injection fluids, clays, sands, production fluids, seawater, any species dissolved or suspended therein (e.g., low density solids, high density solids, etc.), and any combinations thereof.

The treatment fluids may comprise one or more acids. Acids may be inorganic or organic acids, including, for example: hydrochloric acid; hydrobromic acid; hydroiodic acid; hydrofluoric acid; nitric acid; nitrous acid; carbonic acid; phosphoric acid; mineral acids including oxoacids and oxyhalides such as HᵢXOₙ where n=1, 2, 3, 4 and X=F, Cl, Br, I, or i=1, 2, 3 and X=B, C, Si, N, P, S, Se, Sb and n=3, 4 or 5 and any chemically allowable combinations thereof. Other examples include: methane sulfonic acid; formic acid; acetic acid; chloroacetic acid; di-chloroacetic acid; trichloroacetic acid; polyhydroxycarboxylic acids like citric acid; glycolic acid; hydroxyacetic acid; lactic acid; 3-hydroxypropionic acid; aspartic acid; gluconic acid; glucaric acid; or aminopolycarboxylic acids such as ethylenediaminetetraacetic acid (EDTA) or other chelants such as hydroxyethylethylenediaminetriacetic acid (HEDTA), tetrasodium glutamate diacetate (GLDA), methylglycinediacetic acid (MGDA), N-(2-hydroxyethyl)iminodiacetic acid (HEIDA). Other examples include, for example: alkylated phosphonic acid such as an acidic or a neutralized version of N-(Phosphonomethyl)iminodiacetic acid (PMIDA) or salts thereof; N-(carboxymethyl)-N-(phosphonomethyl)glycine; glycine; N,N′-1,2-ethanediylbis(N-(phosphonomethyl); glyphosine; sodium aminotris(methylenephosphonate); N-(2-hydroxyethyl)iminobis (methylphosphonic acid); phosphonic acid; P,P′-((2-propen-1-ylimino)bis(methylene))bis-; phosphonic acid; P,P′,P″-(nitrilotris(methylene))tris-(nitrilotris(methylene))trisphosphonic acid; ((methylimino)-dimethylene)bisphosphonic acid; phosphonic acid, P,P′,P″,P″-(oxybis(2,1-ethanediylnitrilobis-(methylene))tetrakis-((propylimino) bis(methylene))diphosphonic acid; phosphonic P,P′,P″-acid; (nitrilotris(methylene))tris-(ethylenedinitrilo)-tetramethylenephosphonic acid; ethylene-bis(nitrilodimethylene)tetraphosphonic acid; (ethylenebis(nitrilobis(methylene)))tetrakisphosphonic acid; tetrasodium tetrahydrogen (ethane-1,2-diylbis(nitrilobis(methylene)))tetrakisphosphonate; 6-(bis(phosphonomethyl)amino) hexanoic acid; (phenylmethyl)imino)bis(methylene)bisphosphonic acid, 1,2,4-phosphonobutanetricarboxylic acid (PBTCA), aminotris(methylenephosphonic acid) (ATMP), ethylenediaminetetra(methylenephosphonic acid) (EDTMP), diethylenetriaminepenta (methylenephosphonic acid) (DTPMP), hexamethylenediaminetetramethylenephosphonic acid (HDTMP), bishexamethylenetriaminepenta (methylenephosphonic acid) (BHMTMP), 2-hydroxyphosphono dicarboxylic acid; a sodium, potassium, or ammonium salt of any group member herein, and mixtures thereof, or phosphonate ester derivatives. Acid may be individually or cumulatively present in the treatment fluid in an amount from about 1 wt. % to about 45 wt. %. Alternatively, from about 1 wt. % to about 10 wt. %, about 10 wt. % to about 15 wt. %, about 15 wt. % to about 20 wt. %, about 20 wt. % to about 25 wt. %, about 25 wt. % to about 30 wt. %, about 30 wt. % to about 35 wt. %, about 35 wt. % to about 40 wt. %, about 40 wt. % to about 45 wt. %, or any ranges therebetween.

The treatment fluids may include a friction reducer. A friction reducer may reduce the amount of friction experienced by a fluid, thereby reducing the amount of energy required to pump the fluid from the surface to a treated region of a formation and allowing for greater pumping rates and/or lower pumping pressures to achieve those rates. Friction reducers may include, for example, an acrylamide-based compound, compounds having a diallyl functional group, vinyl sulfonate-based compounds, acrylic acid-based compounds, vinyl phosphonic acid-based compounds, or any combinations thereof.

An acrylamide-based (neutral) compound may include, for example: 2-propenamide; methacrylamide, N,N-dimethylacrylamide; N-isopropylacrylamide; 2,3,3-trichloroacrylamide; N,N-methylenebisacrylamide; N,N-ethylenebis(acrylamide); piperazine diacrylamide; N-(isobutoxymethyl) acrylamide; N-hydroxyethyl acrylamide; N-hydroxymethyl acrylamide; N-(3-methoxypropyl) acrylamide); 3-(4-methylphenyl) acrylamide, N-(tert-butyl) acrylamide; N-[(diethylamino)methyl)]acrylamide; N-[(diethylamino)methyl)]acrylamide chloride; N-(1-pyrrolidinylmethyl) acrylamide; N-(1-pyrrolidinylmethyl) acrylamide hydrochloride; N-[2-(acryloylamino)phenyl]acrylamide, 3-Phenyl-N-(4-pyridinyl) acrylamide, N-allyl-3-(2-chlorophenyl) acrylamide; 2-methyl-N-naphthalen-1-yl-acrylamide; N-methoxy-n-methyl-3-phenyl-acrylamide; N-[2-(1H-indol-3-yl)ethyl]acrylamide; 3-(2-chlorophenyl)-n-(2-(4-morpholinyl)ethyl) acrylamide; N-3,5-dichloro-2-hydroxy-4-methyl-phenyl)-2-methyl acrylamide; 3-(4-chloro-phenyl)-n-(2-morpholin-4-yl-ethyl)-acrylamide; 3-(acrylamido)phenylboronic acid; 2-acrylamido-2-methyl-1-propanesulfonic acid; N-vinylsuccinimide; 1-ethenyl-2-imidazolidinone; 1-ethenyl-1,3-dihydro-2H-imidazol-2-one; 1-ethenyl-1,3-dihydro-2H-imidazol-2-one, N,N-(2-hydroxyethyl)-2-propenamide, N,N-Bis(2-hydroxyethyl)-2-methyl-2-propenamide, and any combinations thereof.

An acrylamide-based (charged) polymer may include, for example: N,N,N-Trimethyl-2-[(1-oxo-2-propen-1-yl)amino]ethanaminium chloride; N,N,N-Trimethyl-2-[(1-oxo-2-propen-1-ylamino]ethanaminium sulfate; N,N,N-Trimethyl-2-[(1-oxo-2-propen-1-yl)amino]ethanaminium hydroxide; N,N,N-Trimethyl-2-[(1-oxo-2-propen-1-yl)amino]propanaminium chloride; N,N,N-Trimethyl-2-[(1-oxo-2-propen-1-yl)amino]propanaminium sulfate; N,N,N-Trimethyl-2-[(1-oxo-2-propen-1-yl)amino]propanaminium hydroxide; N,N,N-Trimethyl-2-[(1-oxo-2-propen-1-yl)amino]butanaminium chloride; N,N,N-Trimethyl-2-[(1-oxo-2-propen-1-yl)amino]butanaminium sulfate; N,N,N-Trimethyl-2-[1-oxo-2-propen-1-yl)amino]butanaminium hydroxide; N,N,N-Trimethyl-2-[(1-oxo-2-propen-1-methyl)amino]ethanaminium chloride; N,N,N-Trimethyl-[(1-oxo-2-propen-1-methyl)amino]ethanaminium sulfate; N,N,N-Trimethyl-2-[(1-oxo-2-propen-1-methyl)amino]ethanaminium hydroxide; N,N,N-Trimethyl-2-[(1-oxo-2-propen-1-methyl)amino]propanaminium chloride; N,N,N-Trimethyl-2-[(1-oxo-2-propen 1-methyl)amino]propanaminium sulfate; N,N,N-Trimethyl-2-[(1-oxo-2-propen-1-hydroxide; N,N,N-Trimethyl-2-[(1-oxo-2-propen-1-methyl)amino]propanaminium chloride; N,N,N-Trimethyl-2-[(1-oxo-2-propen-1-methyl)amino]butanaminium sulfate; N,N,N-Trimethyl-2-[(1-oxo-2-propen-1-methyl)amino]butanaminium hydroxide; N,N,N-Trimethyl-4-[(2-1-oxo-2-propen-1-methyl)amino]butanaminium yl)amino]benzenemethanaminium; N,N,N-Trimethyl-4-[(2-methyl-1-oxo-2-propen-1-yl)amino]benzenemethanaminium chloride; N,N,N-Trimethyl-4-[(2-methyl-1-oxo-2-propen-1-yl)amino]benzenemethanaminium sulfate; N,N,N-Trimethyl-4-[(2-methyl-1-oxo-2-propen-1-yl)amino]benzenemethanaminium hydroxide; and any combinations thereof.

Compounds having a diallyl functional group may include, for example: a diallyl sulfide; diallyl sulfone, 3-(2-propen-1-ylsulfonyl)-1-propene; diallyl dimethylammonium; diallyl dimethylammonium chloride; diallyl dimethylammonium sulfate; diallyl dimethylammonium hydroxide; N,N-Bis(2-hydroxyethyl)-N-2-propen-1-yl-2-propen-1-aminium. Other examples include N,N-Bis(2-hydroxyethyl)-N-2-propen-1-yl-2-propen-1-aminium chloride; N,N-Bis(2-hydroxyethyl)-N-2-propen-1-yl-2-propen-1-aminium sulfate; N,N-(2-hydroxyethyl)-N-2-1-yl-2-propen-1-aminium hydroxide; and any combinations thereof.

Vinyl sulfonate-based compounds may include, for example: 2-acrylamido-2-methyl-1-propanesulfonic acid sodium salt; vinyl sulfonic acid; vinyl sulfonic acid sodium salt; 4-vinylbenzenesulfonic acid; 4-vinylbenzenesulfonic acid sodium salt; 5-ethenyl-1,3-benzenedisulfonic acid; 5-ethenyl-1,3-benzenedisulfonic acid sodium salt; 5-ethenyl-2-hydroxy-1,3-benzenedisulfonic; 2-acrylamidoethanesulfonic acid; 2-acrylamidoethanesulfonic acid sodium salt; 2-acrylamidoethanesulfonic acid ammonium salt; 2-methyacylamidoethanesulfonic acid; 3-acrylamidopropanesulfonic acid; 2-acrylamidopropanesulfonic acid sodium salt; 2-acrylamidopropanesulfonic acid ammonium salt; 4-acrylamidobutanesulfonic acid; 2-acrylamidobutanesulfonic acid sodium salt; 2-acrylamidobutanesulfonic acid ammonium salt; and any combinations thereof.

An acrylic acid based compounds may include, for example: acrylic acid; acrylic acid mono-valent salt; acrylic acid di-valent salt; acrylic acid tri-valent salt; methyl acrylate; ethyl acrylate, n-propyl acrylate; isopropyl acrylate; n-butyl acrylate; sec-butyl acrylate; tert-butyl acrylate; 2-methyl-2-propionic acid; ethyl methacrylate; n-propyl methacrylate; isopropyl methacrylate; n-butyl methacrylate; sec-butyl methacrylate; tert-butyl methacrylate; ethyoxylated acrylic acid; ethoxylated methacrylate; propoxylated acrylic acid; propoxylated methacrylate; and any combinations thereof.

An acrylic acid-based (charged) compound may include, for example: (2-acryloyloxyethyl-trimethyl ammonium chloride; (2-acryloyloxyethyl)trimethyl ammonium chloride sulfate; (2-acryloyloxyethyl)trimethyl ammonium hydroxide; N,N,N-Trimethyl-3-[(1-oxo-2-propen-1-yl)oxy]-1-propanaminium chloride; N,N,N-Trimethyl-3-[(1-oxo-2-propen-1-yl)oxy]-1-propanaminium sulfate; N,N,N,-Trimethyl-3-[(1-oxo-2-propen-1-yl)oxy]-1-propanaminium hydroxide; N,N,N-Trimethyl-4-[(1-oxo-2-propen-1-yl)oxy]-1-butanaminium chloride; N,N,N-Trimethyl-4-[(1-oxo-2-propen-1-oxy]-1-butanaminium sulfate; N,N,N-Trimethyl-4-[(1-oxo-2-propen-1-yl)oxy]-1-butanaminium hydroxide; (2-methacryloyloxyethyl)trimethyl ammonium chloride; (2-methacryloyloxyethyl)trimethyl ammonium chloride sulfate; (2-methacryloyloxyethyl)trimethyl ammonium chloride; (2-methacryloyloxyethyl)trimethyl ammonium chloride sulfate; (2-methacryloyloxyethyl)trimethyl ammonium chloride; (2-methacryloyloxyethyl)trimethyl ammonium chloride sulfate; (2-methacryloyloxyethyl)trimethyl ammonium chloride; (2-methacryloyloxyethyl)trimethyl ammonium chloride sulfate; (2-methacryloyloxyethyl)trimethyl ammonium chloride; (2-methacryloyloxyethyl)trimethyl ammonium chloride sulfate; (2-methacryloyloxyethyl)trimethyl ammonium hydroxide; N,N,N-Trimethyl-3-[(1-oxo-2-propen-1-yl)oxy]1-propanaminium chloride; N,N,N,-Trimethyl-3-[(1-oxo-2-propen-1-methyl)oxy]-1-propanaminium sulfate; N,N,N-Trimethyl-3-[(1-oxo-2-propen-1-methyl)oxy]-1-propanaminium hydroxide; N,N,N-Trimethyl-4-[(1-oxo-2-propene-1-methyl)oxy]-1-butanaminium chloride; N,N,N-Trimethyl-4-[(1-oxo-2-propen-1-methyl)oxy]-1-butanaminium sulfate; N,N,N-Trimethyl-4-[(1-oxo-2-propen-1-methyl)oxy]-1-butanaminium hydroxide; and any combinations thereof.

A vinyl phosphonic acid-based compound may include, for example: vinylphosphonic acid; vinylphosphonic acid mono-valent salt; vinylphosphonic acid di-valent salt; vinylphosphonic acid tri-valent salt; (4-Ethenylphenyl)phosphonic acid; P-(4-Ethenylphenyl)phosphonic acid mono-valent salt; P-(4-Ethenylphenyl)phosphonic acid divalent salt; P-(4-Ethenylphenyl)phosphonic acid tri-valent salt; P-(2-Ethenylphenyl)phosphonic acid; P-2-Ethenylphenyl)phosphonic acid mono-valent salt; P-(2-Ethenylphenyl)phosphonic acid di-valent salt; P-2-Ethenylphenyl)phosphonic acid tri-valent salt; P-(3-Ethenylphenyl)phosphonic acid; P-(3-Ethenylphenyl)phosphonic acid mono-valent salt; P-(3-Ethenylphenyl)phosphonic acid di-valent salt; P-(3-Ethenylphenyl)phosphonic acid tri-valent salt; and any combinations thereof.

Other friction reducers may include, for example, a viscoelastic polymer. A viscoelastic polymer may have a molecular weight from about 5,000 kilodaltons to about 20,000 kilodaltons. Alternatively, from about 10,000 to about 13,000 kilodaltons, about 13,000 kilodaltons to about 16,000 kilodaltons, about 16,000 kilodaltons to about 19,000 kilodaltons, about 19,000 kilodaltons to about 25,000 kilodaltons, or any ranges therebetween.

Any of the above-listed friction reducers may be present in a treatment fluid in an amount between about 100 ppm to about 1000 ppm. Alternatively, from about 100 ppm to about 200 ppm, about 200 ppm to about 400 ppm, about 400 ppm to about 600 ppm, about 600 ppm to about 800 ppm, about 800 ppm to about 1000, or any ranges therebetween. In some examples, in an amount from about 0.01 wt. % to about 10 wt. %, about 0.01 wt. % to about 1 wt. %, about 1 wt. % to about 5 wt. %, about 5 wt. % to about 10 wt. %, or any ranges therebetween.

The treatment fluid may comprise a corrosion inhibitor. Corrosion inhibitors may mitigate the corrosive effects of the acid on the metal surfaces of downhole or surface equipment, such as wellbore casings and tubing or internal regions of pumps, tanks, flowlines, etc. Suitable corrosion inhibitors may include, for example: a cinnamaldehyde compound or a derivative thereof; an acetylenic compound such as acetylenic alcohols or the like; a quaternary alkyl or aryl ammonium compound; a urea or thiourea containing monomeric, oligomeric, or polymeric compound; and any combinations thereof. The corrosion inhibitor may be included in the treatment fluid in an amount from about 0.005 wt. % to about 5 wt. %. Alternatively, from about 0.005 to about 0.02 wt. %, about 0.02 wt. % to about 1 wt. %, about 1 wt. % to about 5 wt. %, or any ranges therebetween.

A cinnamaldehyde compound or derivative may include, for example, dicinnamaldehyde, p-hydroxycinnamaldehyde, p-methylcinnamaldehyde, p-ethylcinnamaldehyde, p-methoxy p-diethylaminocinnamaldehyde, cinnamaldehyde, p-dimethylaminocinnamaldehyde, p-nitrocinnamaldehyde, o-nitrocinnamaldehyde, o-allyloxycinnamaldehyde, 4-(3-propenal) cinnamaldehyde, p-sodium Sulfocinnamaldehyde, p-trimethylammoniumcinnamaldehyde Sulfate, p-trimethylammoniumcinnamaldehyde, o-methylsulfate, p-thiocyano cinnamaldehyde, p-(S-acetyl)thiocinnamaldehyde, p-(S N. N-dimethylcarbamoylthio) cinnamaldehyde, p-chlorocinnamaldehyde, C.-methylcinnamaldehyde, B-me thylcinnamaldehyde, C.-chlorocinnamaldehyde, C.-bromo cinnamaldehyde, C.-butylcinnamaldehyde, C.-amylcinnamaldehyde, C.-hexylcinnamaldehyde, C-bromo-p-cyanocinnamaldehyde, O-ethyl-p-methylcinnamaldehyde, p-methyl-C-pentylcinnamaldehyde, cinnamaloxime, cinnamonitrile, 5-phenyl-2,4-pentadienal, 7-phenyl-2,4,6-heptatrienal, or any combination thereof.

An acetylenic compound or acetylenic alcohol may include, for example, methyl butynol, methyl pentynol, hexynol, ethyl octynol, propargyl alcohol, benzylbutynol, ethynylcyclohexanol, ethoxyacetylenics, propoxyacetylenics, and mixtures thereof. Other examples of these types of alcohols may include hexynol, propargyl alcohol, methylbutynol, ethyl octynol, propargyl alcohol ethoxylate, propargyl alcohol propoxylate, or an acetylenic alcohol of octyl-alcohol, propargyl-alcohol, 2-benzoyl-allyl alcohol, 3-phenyl-2-propyn-1-ol, or any combinations thereof.

Other corrosion inhibitors may include, for example: a quaternary alkyl or aryl ammonium compound; a pyridinium compound; an imidazolium compound. Other examples include, for example: N-alkyl, N-cycloalkyl, an N-alkylarylpyridinium halide, N-alkyl, N-cycloalkyl, a N-alkylarylquinolinium halide; a polymer that incorporates into its structure allylamine; vinylamine; lysine; diallyldimethylammonium; vinylpyridine; quinoline (PVQ); vinylpyrrolidone (PVP); vinylcaprolactam (PVC); derivatized cellulose; polyethylenimine (PEI); or polypropylenimine (PPI). Other examples include, for example: a thiol compound comprising thiosorbitol; hydrogen sulfide; methanethiol; thioethanol; 1-thio-2-butanol; 1,2-ethanedithiol; 1,3-propanedithiol; 2-aminoethanethiol; 2-mercaptobenzothiazole; 2-mercaptothiazoline; glycol dimercaptoacetate; mercaptosuccinic acid; thioglycerol; thiolactic acid; cysteine; 6-aino-3-mercaptothiazole; 6-ethoxy-2-mercaptobenzothiazole; glycerol monothioglycolate; monoethanolamine thioglycolate; methyl thioglycolate; isooctyl thioglycolate; ethyl thioglycolate; 2-ethyl hexyl thioglycolate; thioglycolic acid; and any combinations thereof. Other examples include, for example unsaturated hydrocarbons that are classified as: (1) terpenes which contain cyclic components, and which can include such as citral, ocimene, pinene, limonene; or (2) terpenoids such as squalene which are primarily aliphatic.

In some examples, the effectiveness of a corrosion inhibitor may be amplified by an intensifier. Suitable intensifiers may include, for example, potassium iodide, sodium iodide, formic acid, cuprous iodide, antimony-based intensifiers, bismuth-based intensifiers, molybdenum-based intensifiers, triphenylphosphine, triethylphosphine, trimethylphosphine, and any combinations thereof.

The treatment fluid may include a surfactant. A suitable surfactant may include, for example, an anionic surfactant, a cationic surfactant, a non-ionic surfactant, a zwitterionic surfactant, an amphoteric surfactant, or any combination thereof.

An anionic surfactant may include, for example, sulfates, sulfonates, phosphates, phosphonates, carboxylates, and their derivatives. For example, a surfactant may include a metalated, alkyl-, alkenyl, aryl-sulfate such as: ammonium lauryl sulfate, sodium lauryl sulfate, and related alkyl-ether sulfates such as sodium laureth sulfate and sodium myreth sulfate; a surfactant may include a metalated, alkyl-, alkenyl, aryl-sulfonate such as: sodium alkylbenzene sulfonate. Other anionic surfactants include docusate (dioctyl sodium sulfosuccinate), perfluorooctanesulfonate, perfluorobutanesulfonate, A surfactant may also include metalated alkyl-, alkenyl, aryl-phosphates such as alkyl-aryl ether phosphates, metalated alkyl-, alkenyl, aryl-phosphonates such as alkyl-aryl phosphonates, alkyl ether phosphates, alkyl phosphonates. Carboxylates may include metalated, alkyl-, alkenyl, aryl-carboxylates such as: sodium stearate, sodium lauroyl sarcosinate, and carboxylate-based fluorosurfactants such as perfluorononanoate and perfluorooctanoate. Other specific examples of anionic surfactants include, for example, sodium, potassium, and ammonium salts of long chain alkyl sulfonates and alkyl aryl sulfonates (e.g., sodium dodecylbenzene sulfonate), taurates, dialkyl sodium sulfosuccinates (e.g., sodium dodecylbenzene sulfonate, sodium bis-(2-ethylthioxyl)-sulfosuccinate), sodium decylsulfate, alkyl sulfates (e.g., sodium lauryl sulfate), alkyl sulfonates (e.g., methyl sulfonate, heptyl sulfonate, decylbenzene sulfonate, dodecylbenzene sulfonate), alkoxylated sulfates, alkoxylated fatty acids, dodecylbenzenesulfonic acid, sodium cocoyl isethionate, glycol monobutyl ether, alpha-olefin sulfonate, alkylether sulfates, alkyl phosphonates, alkane sulfonates, fatty acid salts, acrylsulfonic acid salts.

A cationic surfactant may include, for example, octenidine dihydrochloride, or a benzalkonium halide such as: cetyltrimethylammonium chloride, cetyl dimethylbenzyl ammonium chloride, trimethyltallowammonium chloride, dimethyldicocoammonium chloride. Cetyl trimethyl ammonium bromide benzalkonium chloride, cocamidopropyl betaine, lauryl dimethylamine oxide, dodecylpyridinium chloride, stearalkonium chloride, hexadecylpyridinium chloride, polyquaternium, behentrimonium chloride, and trimethylammonium bromide. Other examples of cationic surfactants include, for example, alkyl ammonium bromides. Further modifications can be made in order to introduce cationic character to suitable starting materials such as bis(2-hydroxyethyl) tallow amine, bis(2-hydroxyethyl) erucylamine, bis(2-hydroxyethyl) coco-amine, by means of alkoxylation, for example.

A non-ionic surfactant may include, for example, compounds containing hydrophilic groups containing oxygen, the hydrophilic groups bonded to hydrophobic moieties. For example, non-ionic surfactants may include ethoxylated sorbitan esters (polysorbates), such as polysorbate 80. Other non-ionic examples may include triton X-100, as well as ethoxylated alcohols. For example, ethoxylated alcohols may include alkylphenol ethoxylates, linear or branched alcohol ethoxylates, nonylphenol ethoxylates, octylphenol ethoxylates, stearyl alcohol ethoxylates, lauryl alcohol ethoxylates, cetyl alcohol ethoxylates, fatty alcohol ethoxylates, and the like. Other non-ionic examples include sorbitan esters such as sorbitan monostearate, sorbitan tristearate, or sorbitan monolaurate. Other non-ionic surfactants may include, for example, polyglucosides, such as alkyl polyglucosides, alkoxylates of polymeric phenols, alkylphenols, bisphenols, sugars, amines, imines, imidazolines, and simple and complex esters or crosslinked versions thereof.

Other surfactants may include, for example, zwitterionic surfactants. Some zwitterionic surfactants include amphoteric surfactants. Non-limiting examples of amphoteric surfactants may include, for example, betaines (e.g., lauryl betaine, oleamidopropyl betaine, cetyl betaine, cocamidopropyl betaine, etc.), amine oxides (e.g., cocamine oxide, laurylamine oxide, dodecylamine oxide, etc.), sultaines (e.g., cocamidopropyl hydroxysultaine, lauryl hydroxysultaine, etc.), amphoacetates (e.g., cocamphoacetate and disodium cocamphoacetate), alkylamphoacetates (e.g., disodium lauryl amphoacetate and disodium cocoamphodiacetate, etc.), and the like. Amphoteric surfactants may include a cationic moiety (e.g., secondary amine, tertiary amine, quaternary ammonium cation, etc.) as well as an anionic moiety (e.g., sulfonates, sultaine, etc.). Other examples include 3-[(3-cholamidopropyl)dimethylammonio]-1-propanesulfonate, phosphatidylserine, phosphatidylethanolamine, and phosphatidylcholine.

Some zwitterionic are nonamphoteric and do not undergo significant charge changes over a wide range of pH values. Non-limiting examples of nonamphoteric surfactants may include betaine esters (e.g., coco-betaine ester, lauryl-betaine ester, and oleoyl-betaine ester, etc.), phosphobetaines (e.g., phosphatidylcholine, sphingomyelin, etc.), and imadazolines (cocamidopropyl hydroxy sultaine, lauryl hydroxy sultaine, etc.).

A surfactant may, in some examples, include a secondary, tertiary, or quaternary ammonium cation. Specific examples of tertiary amines include, for example, tertiary amine oxides (e.g., lauryldimethylamine oxide, myristamine oxide, etc.). Specific examples of quaternary ammonium salts include, for example, choline hydroxide, cetrimonium bromide, cetylpyridinium chloride, benzalkonium chloride, benzetheonium chloride, dimethyldioctadecylammonium chloride, dioctadecyldimethylammonium bromide, fatty amine ethoxylate quat surfactants, diamine gemini surfactants such as those obtained from alkynyl compounds, and any combinations thereof.

In some examples, a surfactant may include primary, secondary, or tertiary amines. Specific examples may include, dimethyl cocoamine oxide, and lauryl dimethylamine oxide.

In one or more examples, a surfactant may include a synthetic surfactant. Specific examples of synthetic surfactants may include, for example, sulfosuccinates (e.g., dialkyl sodium sulfosuccinate).

Other surfactants may include, for example, linear or branched alkylbenzene sulfonates, lignin sulfonates, siloxane surfactants (e.g., polydimethylsiloxane, silsesquioxane, siloxane-polyether copolymers, polyethyleneoxide modified siloxanes, fluorinated siloxane surfactants, etc.), tall-oil-derived surfactants (e.g., reaction product of tall oil fatty acids with diethylenetriamine, maleic anhydride, tetraethylenepentamine and triethylenetetramine), per- and polyfluoroalkyl substances, fluorinated surfactants (e.g., fluorinated polymer surfactants, cationic fluorosurfactants with cationic and anionic salt moieties, etc.), viscoelastic surfactants (e.g., methyl ester sulfonates, ethoxylated amines), polymeric alkoxylates of phenolic resins, bis-phenol polymers, esters and complex esters thereof, low molecular-weight aliphatic moieties, polar organic functional groups such as amidoamines, amines, amides, silicates, glycols, polyacrylamide, partially hydrolyzed polyacrylamide, polyvinylpyrrodolidone, quaternized alkyl oraryl molecules, conjugates or derivatized macromolecules, oxidizer or oxidizing agents, reducer or reducing agents, metal (oxy) anion salts where the metal is a multivalent (n) cation (n=+2, +3, +4, +5, +6, +7) and the anion is a halide, sulfur or selenium, nitrogen or phosphorous, and combinations thereof. In another example, a surfactant may comprise 1-Acrylamido-2-methylpropanesulfonic acid (AMPS) terpolymer. AMPS terpolymers may be formed from three monomers: AMPS, acrylic acid, and a third monomer, for example, acrylamide, ethylene glycol dimethacrylate, or N,N′-methylenebisacrylamide.

A surfactant may be present in the treatment fluids in an amount from about 0.01 wt. % to about 35 wt. %. Alternatively, from about 0.01 wt. % to about 0.1 wt. %, about 0.1 wt. % to about 1 wt. %, about 1 wt. % to about 5 wt. %, about 5 wt. % to about 10 wt. %, about 10 wt. % to about 15 wt. %, about 15 wt. % to about 20 wt. %, about 20 wt. % to about 35 wt. %, and any ranges therebetween.

The treatment fluids may include a diverter agent. A diverter agent may include, for example, inorganic materials such as rock salts and polymeric materials such as starch or polyester. A diverter agent may include, for example, a aliphatic polyester, polylactic acid, polylactide, polyvinyl alcohol, plasticized polyvinyl alcohol, polysaccharides, lignosulfonates, chitins, chitosans, proteins, proteinous materials, fatty alcohols, fatty esters, fatty acid salts, a naphthalene, a clean tar, a starch, a dextran, a cellulose, a poly(maleic anhydride), a poly(adipic anhydride), a poly(suberic anhydride), a poly(sebacic anhydrie), a poly(dodecanedioic anhydride), a poly(benzoic anhydride), poly(glycolides), poly(&-caprolactones), polyoxymethylene, polyurethanes, poly(hydroxybutyrates), poly(anhydrides), aliphatic polycarbonates, polyvinyl polymers, acrylic-based polymers, poly(amino acids), poly(aspartic acid), poly(alkylene oxides), polyphosphazenes, poly(orthoesters), poly(hydroxy ester ethers), polyether esters, polyester amides, polyamides, polyhydroxyalkanoates, polyethyleneterephthalates, polybutyleneterephthalates, polyethylenenaphthalenates, a montanyl alcohol, a tert-butylhydroquinone, a cholesterol, a cholesteryl nonanoate, a benzoin, a borneol, an exonorborneol, a glyceraldehyde triphenylmethanol, a dimethyl terephthalate, a camphor, a cholecalciferol, a ricinoleyl alcohol, a 1-heptacosanol, a 1-tetratriacontoanol, a 1-dotriacontanol, a 1-hentriacontanol, a 1-tricontanol, a 1-nonacosanol, a 1-octasanol, a 1-hexacosanol, a 1,17-heptadecanediol, a 1,18-octadecanediol, a 1,19-nonadecanediol, a 1,20-eicosanediol, a 1,21-heneicosanediol, a 1,22-docosanediol, a myricyl alcohol, prednisolone acetate, cellobiose tetraacetate, terephthalic acid dimethyl ester, or any combinations thereof. A diverter agent may be self-degrading. Where used, a diverter agent may at least partially plug a permeable zone in the subterranean formation, thereby diverting at least a portion of a fluid to less permeable sections of the formation.

The treatment fluid may include a scavenger. A scavenger may include, for example, an H₂S scavenger, a CO₂ scavenger, an O₂ scavenger, an acid scavenger, or a combination thereof. Scavengers may serve to remove or neutralize unwanted substances or contaminants from the wellbore or a wellbore fluid.

The treatment fluid may include a chelating agent. A chelating agent may include, for example, ammonium, hydroxyethylenediaminetetraacetic acid (EDTA), N-(2-hydroxethyl)ethylenediaminetriacetic acid (HEDTA), hydroxyethyliminodiacetic acid (HEIDA), methylglycine diacetic acid (MGDA), L glutamic acid, N,N-diacetic acid (GLDA), ethylenediaminedisuccinic acid (EDDS), beta-alaninediacetic acid (beta-ADA), diethylenetriaminepentaacetic acid (DTPA), cyclohexylenediaminetetraacetic acid (CDTA), nitrilotriacetic acid (NTA), diphenylaminesulfonic acid (DPAS), phosphonic acid, alkylphosphonic acids or phosphonate salts where the alkyl group is any that provides sufficient aqueous solubility in the pH range of interest, citric acid, iminodiacetic acid, gluconic acid, and ammonium, alkali (Group I metal) or alkaline-earth (Group 2 metal) salts thereof, and combinations thereof. Factors to consider when selecting a chelating agent may include pH, temperature, ionic strength, and/or solubility.

The treatment fluid may include a scale inhibitor. A scale inhibitor may include, for example, polyphosphates, phosphate esters, phosphonates, phosphonate esters, polyacrylic acid and salts thereof, and other carboxylic acid-containing polymers. A scale inhibitor may serve to prevent or slow the formation of scale on the inner surface of a wellbore casing.

The treatment fluid may include a viscosifier. A viscosifier may include, for example, an arganophilic bentonite, an organophilic attapulgite, a polysaccharide, a biopolymer such as xanthan or succinoglycan, a cellulose derivate such as hydroxyethylcellulose, and guar and its derivatives such as hydroxypropyl guar, and any combinations thereof. A viscosifier may be present in the treatment fluid in an amount from about 0 wt. % to about 1 wt. %, or any ranges therebetween, for example, from about 0.13 wt. % to about 0.16 wt. %.

The treatment fluid may include a dispersant. A dispersant may include, for example, a sulfonated-formaldehyde-based dispersant (e.g., sulfonated acetone formaldehyde condensate), polycarboxylated ether dispersants, polyoxyethylene phosphates, polyox polycarboxylates, or the like. Where used, a dispersant may reduce droplet size and improve separation of particles to reduce clumping or settling. Additionally, the treatment fluid may include an anti-sludging agent to prevent agglomeration of charged components in a crude, such as naphthenic acids, asphaltenes, and the like.

The treatment fluid may include a wetting agent. A wetting agent may alter wettability of a subterranean formation, making it either more water-wet or more oil-wet. A wetting agent may include, for example: sulfosuccinates; alkylphenol ethoxylates; and gemini-surfactants previously listed. Adsorption of a wetting agent to a surface of the subterranean formation may alter the hydrophobicity or the oleophobicity of the surface, thereby altering the wettability and changing the contact angle of an aqueous or oleaginous fluid with the surface.

The treatment fluid may include a lightweight additive. A lightweight additive may include, for example, bentonite, coal, diatomaceous earth, expanded perlite, fly ash, gilsonite, hollow microspheres, low-density elastic beads, nitrogen, pozzolan-bentonite, sodium silicate, or combinations thereof. In some examples, it may be desirable to include a lightweight additive to reduce an overall specific gravity or a density of the treatment fluid.

The treatment fluid may include weighting agents. Weighting agents are typically materials that weigh more than water and may be used to increase an overall specific gravity of a treatment fluid. By way of example, weighting agents may have a specific gravity of about 2 or higher (e.g., about 2, about 4, etc.). A weighting agent may include, for example: calcium chloride; calcium bromide; cesium salts such as bromide, iodide, or formate; zinc bromide; zinc iodide, zinc formate; hematite; hausmannite; barite; and any combinations thereof.

The treatment fluid may include an acid precursor or a delayed acid precursor. An acid precursor or delayed acid precursor may include compounds which, while not initially acidic, may degrade or react to release or generate acid. Acid precursors may include, for example, esters, orthoesters, poly(ortho ester), lactic acid derivatives, methyl lactate, ethyl lactate, propyl lactate, butyl lactate, formate esters, ethylene glycol, monoformate, ethylene glycol diformate, diethylene glycol diformate, glyceryl monoformate, glyceryl diformate, glyceryl triformate, triethylene glycol diformate, formate esters of pentaerythritol, esters of propionic acid, esters of butyric acid, esters of monochloroacetic acid, esters of glycolic acid, polyols such as glycerol and glycols, water-soluble formates, ethylene glycol monoformate, diethylene glycol diformate, esters of glycerol, polyesters of glycerol, tripropionin trilactin, esters of acetic acid, esters of glycerol, monoacetin, diacetin, triacetin, aliphatic polyesters, poly(lactides), poly(glycolides), poly(ε-caprolactones, poly(hydroxybutyrates), poly(anhydrides), aliphatic polycarbonates, poly(amino acids), polyphosphazenes, copolymers thereof, and derivatives and combinations thereof. In one or more examples, ester linkage of a reactive ester (e.g., acid precursor) may be hydrolyzed by water to release an acidic species. Other examples include, for example: urea or aminoacid complex of hydrochloric acid, whereby the complex is further stabilized against thermodynamic aqueous dissociation by means of select surfactants.

The treatment fluid may include a filter cake removal agent. A filter cake removal agent may include, for example, an acid precursor or delayed acid precursor and optionally, an initiator component (e.g., lactate oxidase). In other examples, a filter cake removal agent may include a mutual solvent precursor (e.g., glycol ethers, ethylene glycol monobutylether, propylene glycol monobutylether, diethyle glycol monobutylether, triethylene glycol monobutylether, mineral oils, paraffins, methanol, isopropyl alcohol, alcohol ethers, aldehydes, ketones, aromatics solvents), such as an esterified mutual solvent precursor. Where used, a filter cake removal agent may assist with removing oil-based filter cake or water-based filter cake from the subterranean formation.

The treatment fluid may comprise ammonium salt of the halide, or oxyanion, or hydroxide, or chalcogen (Group 16), or quaternary alkyl (or aryl) ammonium salt, where halide is one of chloride or any Group 17 element, where the oxyanion is one of the type oxoacids and oxyhalides such as HᵢXOₙ where n=1, 2, 3, 4 and X=F, Cl, Br, I, or i=1, 2, 3 and X=B, C, Si, N, P, S, Se, Sb and n=3, 4 or 5 and any chemically allowable combinations thereof, such as sodium nitrite or sodium hypochlorite.

The treatment fluid may comprise a thermos-chemical agent. Suitable thermos-chemical agents may include, for example, ammonium chloride and sodium nitrite. A thermos-chemical agent(s) may be individually or collectively present in the treatment fluid in a concentration of about 0.5 wt. % to about 15 wt. %. Alternatively, from about 0.5 wt. % to about 1 wt. %, about 1 wt. % to about 5 wt. %, about 5 wt. % to about 10 wt. %, about 10 wt. % to about 25 wt. %, or any ranges therebetween.

The treatment fluid may optionally include additional additives to suit a particular application. These additional additives may include, for example, fluid loss control additives, foaming agents, antifoaming agents, lubricants, breakers, relative permeability modifiers, resins, coating enhancement agents, carbon dioxide, nitrogen, natural gas, antifreeze agents (e.g., ethylene glycol), pumping agents, producing agents, flocculants, a pH-adjusting agent (e.g., buffer), a biocide, and any combinations thereof. Other additional additives may include, for example, salts, solvents, organic corrosion inhibitors and intensifiers, catalysts, clay stabilizers, bactericides, gases, iron control agents, solubilizers, and the like.

Any of the components of the treatment fluid may, whether individually or in combination, have a mean particle size in a from, for example, about 5 microns to about 7,000 microns. Alternatively, from about 5 microns to about 10 microns, about 10 microns to about 20 microns, about 20 microns to about 50 microns, about 50 microns to about 70 microns, about 70 microns to about 100 microns, about 100 microns to about 200 microns, about 200 microns to about 500 microns, about 500 microns to about 1000 microns, about 1000 microns to about 3000 microns, about 3000 microns to about 7000 microns, or any ranges therebetween. In some examples, a treatment fluid may have a multi-modal particle size distribution. By way of example, the treatment fluid may have 2, 3, 4, 5, 6, or more modal peaks. Modal peaks occur on a particle size distribution curve when there are increased particle concentrations relative to particle sizes on either side of the curve.

The treatment fluid generally should have a density suitable for a particular application. For example, the treatment fluid may have a density from about 600 kilograms per cubic meter to about 3000 kilograms per cubic meter. Alternatively, from about 600 kilograms per cubic meter to about 900 kilograms per cubic meter, about 900 kilograms per cubic meter to about 1100 kilograms per cubic meter, about 1100 kilograms per cubic meter to about 1300 kilograms per cubic meter, about 1300 kilograms per cubic meter to about 1500 kilograms per cubic meter, about 1500 kilograms per cubic meter to about 1700 kilograms per cubic meter, about 1700 kilograms per cubic meter to about 1900 kilograms per cubic meter, about 1900 kilograms per cubic meter to about 2100 kilograms per cubic meter, about 2100 kilograms per cubic meter to about 2300 kilograms per cubic meter, about 2300 kilograms per cubic meter to about 2500 kilograms per cubic meter, about 2500 kilograms per cubic meter to about 2700 kilograms per cubic meter, about 2700 kilograms per cubic meter to about 3000 kilograms per cubic meter, and any ranges therebetween.

The treatment fluid may have a viscosity from about 0.8 centipoise to about 10 centipoise. Alternatively, from about 0.8 centipoise to about 1 centipoise, about 1 centipoise to about 2 centipoise, about 2 centipoise to about 4 centipoise, about 4 centipoise to about 8 centipoise, about 8 centipoise to about 12 centipoise, or any ranges therebetween.

In some examples, the treatment fluid may have a specific gravity of about 0.5 to about 3. Alternatively, from about 0.1 to about 0.8, about 0.8 to about 1, about 1 to about 1.2, about 1.2 to about 1.5, about 1.5 to about 1.7, about 1.7 to about 2, about 2 to about 2.2, about 2.2 to about 2.5, about 2.5 to about 3, or any ranges therebetween.

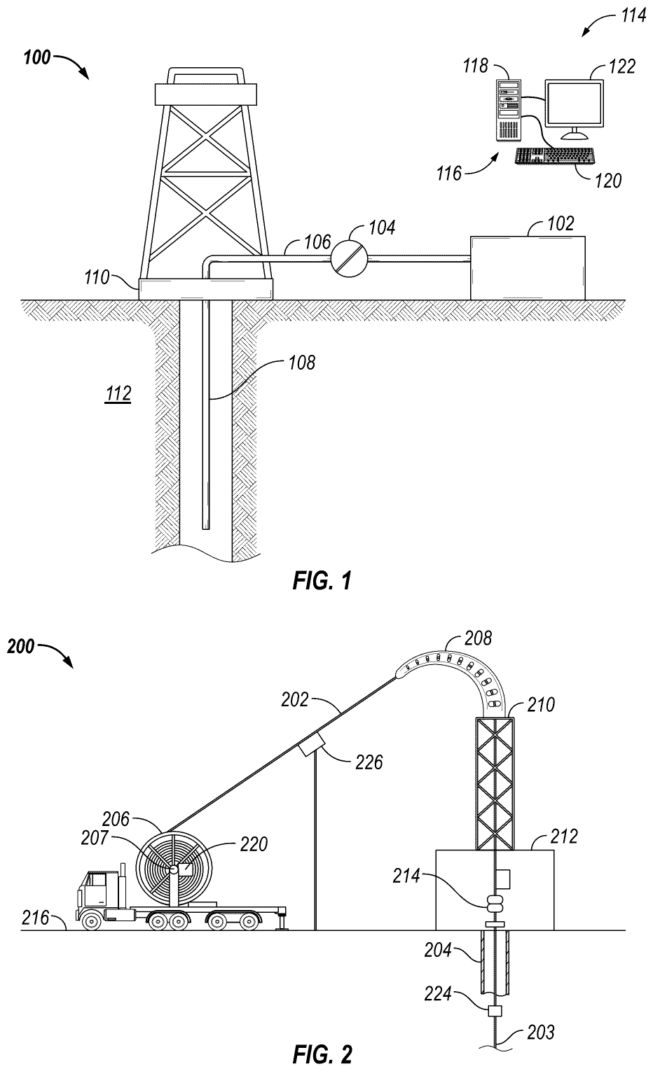

FIG. 1 illustrates wellbore configuration for delivering a treatment fluid to a wellbore, in accordance with certain examples of the present disclosure. As illustrated, surface equipment 100 may include a mixing tank 102, a pump 104, and a wellhead 110. It should be understood that while the figures depict land-based operations, the teachings herein disclosed may be equally applied to subsea environments.

Treatment fluid may be prepared in mixing tank 102. Alternatively, preparation of the treatment fluid may be performed at an off-site location and transported to a job site using, for example, a vehicle. Shear may be applied to the treatment fluid, or to one or more components of the treatment fluid prior to introduction to subterranean formation 112. The treatment fluid may be conveyed via line 106 to wellhead 110, where the treatment fluid enters tubular 108. Tubular 108 may extend from wellhead 110 into subterranean formation 112. Tubular 108 may comprise one or more layers of metal casing. Upon entering subterranean formation 112 via tubular 108, the treatment fluid may contact subterranean formation 112. Pump 104 may pressurize treatment fluid to a predetermined pressure prior to and/or during pumping of treatment fluid into a wellbore. It is to be recognized that FIG. 1 is merely exemplary in nature and various additional components may be present which are not necessarily depicted for the sake of brevity. Non-limiting additional components which may be present may include supply hoppers, valves, condensers, adapters, joints, gauges, sensors, compressors, pressure controllers, pressure sensors, flow rate controllers, flow rate sensors, temperature sensors, and the like.

Measurements taken of the treatment fluid and of the condition of wellbore (such as using gauges, sensors, compressors, pressure controllers, pressure sensors, flow rate controllers, flow rate sensors, temperature sensors, and the like) may be sent to and/or analyzed by an information handling system 114. Information handling system 114 may include any instrumentality or aggregate of instrumentalities operable to compute, estimate, classify, process, transmit, receive, retrieve, originate, switch, store, display, manifest, detect, record, reproduce, handle, or utilize any form of information, intelligence, or data for business, scientific, control, or other purposes. For example, an information handling system 114 may be a personal computer, a network storage device, or any other suitable device and may vary in size, shape, performance, functionality, and price. Information handling system 114 may include a processing unit 116 (e.g., microprocessor, central processing unit, etc.) that may process any form of data disclosed herein by executing software or instructions obtained from a local non-transitory machine-readable media 118 (e.g., optical disks, magnetic disks). Non-transitory machine-readable media 118 may store software or instructions of the methods described herein. Non-transitory machine-readable media 118 may include any instrumentality or aggregation of instrumentalities that may retain data and/or instructions for a period of time. Non-transitory machine readable media 118 may include, for example, storage media such as a direct access storage device (e.g., a hard disk drive or floppy disk drive), a sequential access storage device (e.g., a tape disk drive), compact disk, CD-ROM, DVD, RAM, ROM, electrically erasable programmable read-only memory (EEPROM), and/or flash memory; as well as communications media such wires, optical fibers, microwaves, radio waves, and other electromagnetic and/or optical carriers; and/or any combination of the foregoing. Information handling system 114 may also include input device(s) 120 (e.g., keyboard, mouse, touchpad, etc.) and output device(s) 122 (e.g., monitor, printer, etc.). The input device(s) 120 and output device(s) 122 provide a user interface that enables an operator to interact and/or change downhole operations and/or software executed by processing unit 116. For example, information handling system 114 may enable an operator to select analysis options, view collected log data, view analysis returns, and/or perform other tasks.

In embodiments, the non-transitory machine readable media 118 may store instructions to set a surface treating pressure range for a first stage of a multistage fracturing job, instructions to introduce a treatment fluid into a wellbore extending into a subterranean formation, instructions to measure a surface treating pressure, instructions to change a concentration of the friction reducer to have at least two surface treating pressure measurements within the surface treating pressure range, instructions to establish a relationship between the surface treating pressure measurements and the concentrations of the friction reducer, instructions to evaluate a treatment fluid performance metric based on the relationship between the surface treating pressure measurements and the concentrations of the friction reducer, and instructions to select the concentration of the friction reducer for a second stage of the multistage fracturing job based at least in part on the treatment fluid performance metric.

As will be discussed later in detail, the present disclosure may provide treatment fluids which may be pumped at high rates. These high rates may, in some examples, be accompanied by lower pumping pressures than would be conventionally feasible. For example, the disclosed treatment fluids may be pumped into one or more wellbores at a rate of about 2 barrels per minute to about 200 barrels per minute. Alternatively, from about 2 barrels per minute to about 20 barrels per minute, about 20 barrels per minute to about 40 barrels per minute, about 40 barrels per minute to about 60 barrels per minute, about 60 barrels per minute to about 100 barrels per minute, about 100 barrels per minute to about 200 barrels per minute, or any ranges therebetween. Pumping pressure to carry out a pumping rate of at least 20 barrels per minute may be, for example, less than 40 MPa. Pumping pressure to carry out a pumping rate of at least 40 barrels per minute may be, for example, less than 80 MPa. Pumping pressure to carry out a pumping rate of at least 100 barrels per minute may be, for example, less than 140 MPa.

FIG. 2 is a wellbore servicing system 200. In an example, surface equipment 100 (e.g., referring to FIG. 1) may comprise coiled tubing 202 having an end 203 deployed into a wellbore 204 at surface 216. The coiled tubing 202 may be provided from a coiled tubing spool 206 having an axle 207, where the coiled tubing spool 220 plays out the coiled tubing 202 when the end 203 is driven into the wellbore 204 and that takes up the coiled tubing 202 when the end 203 is pulled out from the wellbore 204. Coiled tubing 202 may be moved into and out of wellbore 204 with an injector. Coiled tubing 202 may be supported by a gooseneck 208 coupled to a mast 210 or other supporting structure. The mast 210 or other support structure may be supported by a substructure 212. Coiled tubing 202 may be stabbed into and fed through a blowout preventer (BOP) stack 214 or a completion Christmas tree. The coiled tubing spool 206 may be referred to as the spool 206. In addition, wellbore servicing system 200 may comprise one or more sensors 224, and 226 for measuring an orientation (e.g., angle) and/or location of coiled tubing 202 and/or collars disposed in wellbore 204. End 203 may be disposed at various depths or locations within wellbore 204 and the treatment fluid may be introduced into wellbore 204 via coiled tubing 202 at the various depths or locations. As previously mentioned, pumping pressure required to pump the treatment fluid through coiled tubing 202 and/or into the subterranean formation may be reduced by the inclusion of one or more friction reducers in the treatment fluid.

As illustrated, coiled tubing 202 may comprise a long continuous flexible conduit which may be wound or unwound on a coiled tubing spool 220. Alternatively, the treatment fluid may be pumped into the subterranean formation 112 via a rigid conduit (e.g., stick pipe). In either coiled tubing or rigid conduit examples, conduit may be lowered to a desired depth in the wellbore and the treatment fluid may be pumped through the conduit and introduced into the wellbore or the subterranean formation 112. The treatment fluid may be pumped through coiled tubing or a rigid conduit using less time and energy than what would be otherwise possible due to the effects of the friction reducer on pumping rates and pressure head requirements for pumping through a coiled tube or rigid conduit. The friction reducer, in addition to reducing turbulence within fluid flow through the coiled tubing or rigid conduit, may also decrease the amount of friction experienced by the treatment fluid as a result of any surface roughness of the inner surface of the conduits.

In a multistage fracturing job, multiple quasi-parallel fractures or fracture sets are created with a certain spacing along the length of a well by pumping high-pressure water-based fluids and sand-like proppants through a perforated casing or an open-hole interval in the well. The objective is to increase the contact surface area between the formation and the wellbore, create a distributed and connected network of fractures into a rock volume around the wellbore to increase the reservoir fluid volume contributing to production from the well. This is required to recover a larger volume of fluid with a lower pressure drop and to increase the production life of the well. This also implies a fewer number of wells required to be drilled at surface for extracting a certain volume of hydrocarbon reserves. Fewer wells mean substantially lower capital and operational cost, a smaller surface footprint, and less water volume needed, all of which are important factors for energy sustainability. Each fracture or fracture-set in a multistage fracturing operation corresponds to one pumping stage and, therefore, multistage fracturing is an extension of its predecessor, single-stage hydraulic fracturing.

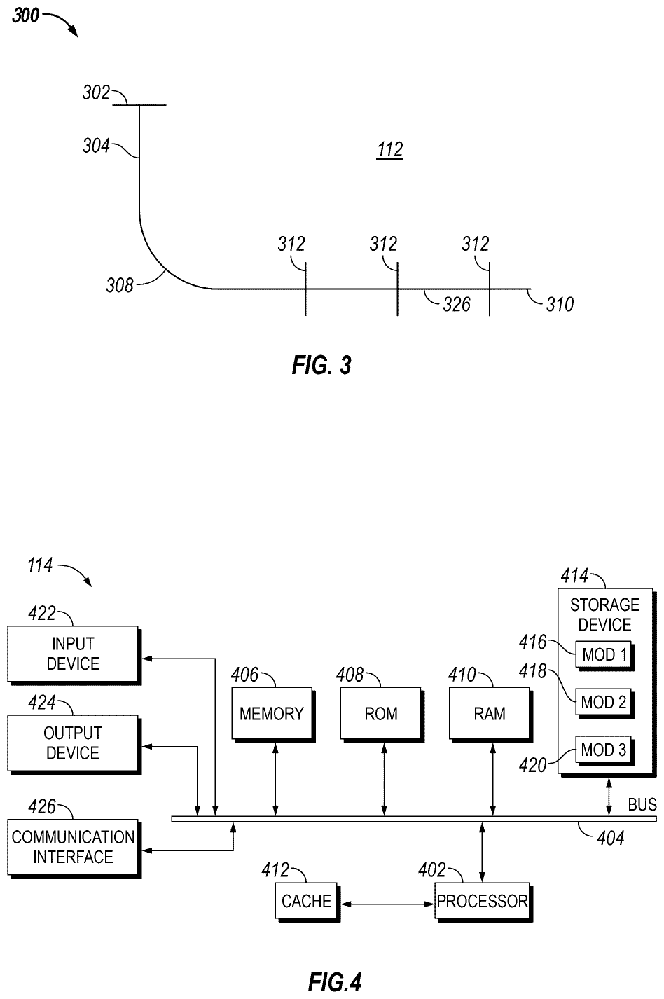

FIG. 3 is a wellbore servicing system 300. In an example, surface equipment 100 (e.g., referring to FIG. 1) may transmit treatment fluid into wellbore 304 disposed in subterranean formation 112. The treatment fluid is injected into the well at sufficient pressure to induce fractures or else enlarge pre-existing fractures within the formation. The treatment fluid may include proppant, which props open the induced fractures to further enhance production. Proppant may include, for example, sand, sintered bauxite, glass balls, polystyrene beads, microproppant, and the like.

As illustrated, at least a portion of wellbore 304 may be disposed horizontally in the subterranean formation 112, with a heel section 308 and a toe section 310. The treatment fluid may be delivered to subterranean formation 112 at high or low pressures through a plurality of openings in a wellbore casing. Delivery of a treatment fluid may be performed by isolating stages using one or more bridge plugs. Delivery of the treatment fluid may or may not result in various fractures 312, including transverse and/or longitudinal fractures.

As illustrated, wellbore 304 may comprise toe section 310, heel section 308, and horizontal section 326, with the toe section 310 positioned further away from surface 302 than heel section 308. As mentioned, horizontal or vertical stages may be temporarily isolated from each other using bridge plugs. A single stage may have a length of, for example, up to 3,000 meters or more. The wellbore casing at each stage may be perforated to allow the wellbore to communicate with the formation.

The treatment fluids of the present disclosure may be introduced to a subterranean formation as a single treatment fluid or in various stages. For example, a treatment fluid comprising the friction reducer, an acidizing fluid, as well as one or more corrosion inhibitors and other chemical additives may be prepared at the surface and introduced into the subterranean formation. In other examples, a treatment fluid comprising the friction reducer (with or without the acid) may be first used to prime the well before later introduction of an acidizing fluid.

In examples, the treatment fluid may be pumped into the subterranean formation 112 as part of a wellbore cleanout. During drilling, construction, or production of a well, debris such as sand, scale, organic materials, and other debris may form in the wellbore. For example, some reservoirs may produce “fines” such as sand which may not be carried to the surface by the production fluid. This debris may periodically need to be removed. The treatment fluid of the present disclosure may be used to at least partially dissolve and/or remove this debris. Particularly, the friction reducers herein disclosed may allow for faster pumping of the treatment fluid and/or lower the amount of energy losses of performing wellbore cleanout. This may allow the treatment fluids to include higher concentrations of acids or else lower pHs than what would typically be allowed since the treatment fluids may be introduced faster into the formation and thus reduce the time of exposure to the tools, tubulars, and other downhole components susceptible to acid corrosion.

In other examples, the treatment fluid may be pumped into subterranean formation 112 (e.g., referring to FIG. 1) as part of a filter cake removal operation. Filter cake removal is the removal of filter cake from a borehole and may be performed prior to tubular make-up of a wellbore casing. In contrast to a scale removal operation, which is typically performed after installation of a wellbore casing, filter cake removal removes substance formed on the surface of the borehole prior to construction of the wellbore. Filter cake may comprise materials deposited from, for example, wellbore fluids such as drilling and drill-in fluids, which forms a semi-permeable medium through which, if not removed, may interfere with production by requiring production fluid to migrate through. Among other things, filter cake may cause stuck pipes, drilling problems, reduced production rates, and in some scenarios, reservoir damage. To mitigate these effects, the filter cake may be removed by pumping the treatment fluid into the borehole and allowing the treatment fluid to contact the filter cake for a sufficient amount of time to at least partially dissolve or otherwise free the filter cake from the borehole surface. After the filter cake is partially dissolved or dislodged from the borehole, it may be flushed out with flush fluid. The treatment fluid of the present disclosure may allow for filter cake removal operations to be performed using less time and energy, since the friction reducers may enable the treatment fluids to be introduced at higher flow rates, result in reduced friction losses, a lower the surface treating pressure requirement, etc.

In other examples, the treatment fluid may be pumped into subterranean formation 112 (e.g., referring to FIG. 1) as part of a scale removal operation. Scale removal is the removal of scale from the part of the subterranean formation in communication with the wellbore, as well as from any internal regions of a wellbore or wellbore casing where buildup of scale has occurred. Scale is a deposit formed on the surface of a metal, rock, or material, and may be caused by precipitation of one or more components of a reservoir or wellbore fluid. Precipitation of scale may be caused by chemical reactions, a change in pressure or temperature, or a change in the concentration of a chemical species in the fluid. Metal corroded by acid may also take part in the scale deposition process. Scale may comprise calcium carbonate, gypsum, anhydrite, barite (e.g., barium sulfate), celestite (e.g., strontium sulfate), calcium sulfate, iron sulfide, iron oxide, iron carbonate, various silicates, phosphates, oxides, mineral salt, and other compounds having low water-solubility. In some cases, scale build-up may seriously restrict flow or even plug tubulars or wellbore casing. Removal of scale may be performed using the treatment fluid of the present disclosure and optionally, mechanical tools (e.g., wellbore intervention tools). Mechanical tools may include, for example, scrapers, pigs, and other intervention tools. The treatment fluid of the present disclosure may allow for scale removal operations to be performed using less time and energy, since the friction reducers may allow for higher pumping/flow rates, reduced energy losses, reduced surface treating pressure requirement, etc.

In other examples, the treatment fluid may be pumped into subterranean formation 112 (e.g., referring to FIG. 1) as part of a gravel pack clean out operation. Gravel packing is a sand-control method sometimes performed during wellbore completion for preventing production of formation sand and may involve placement of a steel screen in the wellbore and specifically-sized gravel in the wellbore annulus. The gravel introduced during gravel packing stabilizes the formation without inhibiting production. During production, interstitial spaces within the gravel may accumulate debris or other fouling materials that block or interfere with production. The treatment fluid may be introduced into a gravel pack to remove or dissolve the interfering material. The reduced friction of the treatment fluids of the present disclosure may allow for quicker flow and therefore faster permeation of the treatment fluid into the gravel pack.

In other examples, the treatment fluid may be pumped into subterranean formation 112 (e.g., referring to FIG. 1) as part of a frac-pac clean-out operation. Frac packing is a wellbore completion technique that serves to perform both gravel packing and hydraulic fracturing. In frac packing, proppant may serve both to prop open the formation and, like a gravel pack, fill spaces and voids (e.g., annulus) around the wellbore and stabilize the wellbore. The “frac-pac” left behind by a frac packing operation is analogous to a gravel pack and serves a similar purpose. The treatment fluid of the present disclosure is equally applicable for cleaning out a frac-pac as for cleaning out a gravel pack and may exhibit similar advantages of quicker flow and reduced energy loss.

In other examples, the treatment fluid may be pumped into subterranean formation 112 (e.g., referring to FIG. 1) as part of a re-fracturing or re-stimulation treatment of a previously hydraulically fractured well. As previously discussed, a wellbore may be hydraulically fractured or acidized with the treatment fluid. In some scenarios, it may be desirable to re-fracture or re-acidize the wellbore. During operations, treatment fluid may need to be altered in order to maximize efficiency within the wellbore. Systems and methods to determine the type of alteration to the treatment fluid may be performed on in information handling system.

FIG. 4 further illustrates an example information handling system 114 which may be employed to perform various steps, methods, and techniques disclosed herein. Persons of ordinary skill in the art will readily appreciate that other system examples are possible. As illustrated, information handling system 114 comprises a processing unit (CPU or processor) 402 and a system bus 404 that couples various system components including system memory 406 such as read only memory (ROM) 408 and random-access memory (RAM) 410 to processor 402. Processors disclosed herein may all be forms of this processor 402. Information handling system 114 may comprise a cache 412 of high-speed memory connected directly with, in close proximity to, or integrated as part of processor 402. Information handling system 114 copies data from memory 406 and/or storage device 414 to cache 412 for quick access by processor 402. In this way, cache 412 provides a performance boost that avoids processor 402 delays while waiting for data. These and other modules may control or be configured to control processor 402 to perform various operations or actions. Other system memory 406 may be available for use as well. Memory 406 may comprise multiple different types of memory with different performance characteristics. It may be appreciated that the disclosure may operate on information handling system 114 with more than one processor 402 or on a group or cluster of computing devices networked together to provide greater processing capability. Processor 402 may comprise any general-purpose processor and a hardware module or software module, such as first module 416, second module 418, and third module 420 stored in storage device 414, configured to control processor 402 as well as a special-purpose processor where software instructions are incorporated into processor 402. Processor 402 may be a self-contained computing system, containing multiple cores or processors, a bus, memory controller, cache, etc. A multi-core processor may be symmetric or asymmetric. Processor 402 may comprise multiple processors, such as a system having multiple, physically separate processors in different sockets, or a system having multiple processor cores on a single physical chip. Similarly, processor 402 may comprise multiple distributed processors located in multiple separate computing devices but working together such as via a communications network. Multiple processors or processor cores may share resources such as memory 406 or cache 412 or may operate using independent resources. Processor 402 may comprise one or more state machines, an application specific integrated circuit (ASIC), or a programmable gate array (PGA) including a field PGA (FPGA).

Each individual component discussed above may be coupled to system bus 404, which may connect each and every individual component to each other. System bus 404 may be any of several types of bus structures including a memory bus or memory controller, a peripheral bus, and a local bus using any of a variety of bus architectures. A basic input/output (BIOS) stored in ROM 408 or the like, may provide the basic routine that helps to transfer information between elements within information handling system 114, such as during start-up. Information handling system 114 further comprises storage devices 414 or computer-readable storage media such as a hard disk drive, a magnetic disk drive, an optical disk drive, tape drive, solid-state drive, RAM drive, removable storage devices, a redundant array of inexpensive disks (RAID), hybrid storage device, or the like. Storage device 414 may comprise software modules 416, 418, and 420 for controlling processor 402. Information handling system 114 may comprise other hardware or software modules. Storage device 414 is connected to the system bus 404 by a drive interface. The drives and the associated computer-readable storage devices provide nonvolatile storage of computer-readable instructions, data structures, program modules and other data for information handling system 114. In one aspect, a hardware module that performs a particular function comprises the software component stored in a tangible computer-readable storage device in connection with hardware components, such as processor 402, system bus 404, and so forth, to carry out a particular function. In another aspect, the system may use a processor and computer-readable storage device to store instructions which, when executed by the processor, cause the processor to perform operations, a method or other specific actions. The basic components and appropriate variations may be modified depending on the type of device, such as whether information handling system 114 is a small, handheld computing device, a desktop computer, or a computer server. When processor 402 executes instructions to perform “operations”, processor 402 may perform the operations directly and/or facilitate, direct, or cooperate with another device or component to perform the operations.

As illustrated, information handling system 114 employs storage device 414, which may be a hard disk or other types of computer-readable storage devices which may store data that are accessible by a computer, such as magnetic cassettes, flash memory cards, digital versatile disks (DVDs), cartridges, random access memories (RAMs) 410, read only memory (ROM) 408, a cable containing a bit stream and the like, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with information handling system 114, an input device 422 represents any number of input mechanisms, such as a microphone for speech, a touch-sensitive screen for gesture or graphical input, keyboard, mouse, motion input, speech and so forth. Additionally, input device 422 may receive one or more measurements from operations within the wellbore. An output device 424 may also be one or more of a number of output mechanisms known to those of skill in the art. In some instances, multimodal systems enable a user to provide multiple types of input to communicate with information handling system 114. Communications interface 426 generally governs and manages the user input and system output. There is no restriction on operating on any particular hardware arrangement and therefore the basic hardware depicted may easily be substituted for improved hardware or firmware arrangements as they are developed.

As illustrated, each individual component described above is depicted and disclosed as individual functional blocks. The functions these blocks represent may be provided through the use of either shared or dedicated hardware, including, but not limited to, hardware capable of executing software and hardware, such as a processor 402, that is purpose-built to operate as an equivalent to software executing on a general-purpose processor. For example, the functions of one or more processors presented in FIG. 4 may be provided by a single shared processor or multiple processors. (Use of the term “processor” should not be construed to refer exclusively to hardware capable of executing software.) Illustrative embodiments may comprise microprocessor and/or digital signal processor (DSP) hardware, read-only memory (ROM) 408 for storing software performing the operations described below, and random-access memory (RAM) 410 for storing results. Very large-scale integration (VLSI) hardware embodiments, as well as custom VLSI circuitry in combination with a general-purpose DSP circuit, may also be provided.

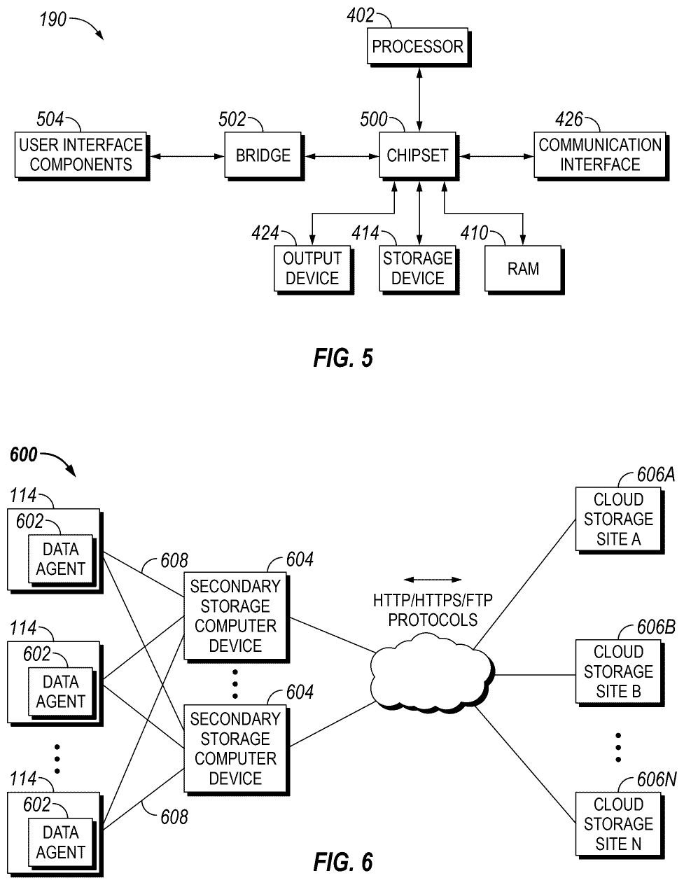

FIG. 5 illustrates an example information handling system 114 having a chipset architecture that may be used in executing the described method and generating and displaying a graphical user interface (GUI). Information handling system 114 is an example of computer hardware, software, and firmware that may be used to implement the disclosed technology. Information handling system 114 may comprise a processor 402, representative of any number of physically and/or logically distinct resources capable of executing software, firmware, and hardware configured to perform identified computations. Processor 402 may communicate with a chipset 500 that may control input to and output from processor 402. In this example, chipset 500 outputs information to output device 424, such as a display, and may read and write information to storage device 414, which may comprise, for example, magnetic media, and solid-state media. Chipset 500 may also read data from and write data to RAM 410. A bridge 502 for interfacing with a variety of user interface components 504 may be provided for interfacing with chipset 500. Such user interface components 504 may comprise a keyboard, a microphone, touch detection and processing circuitry, a pointing device, such as a mouse, and so on. In general, inputs to information handling system 114 may come from any of a variety of sources, machine generated and/or human generated.

Chipset 500 may also interface with one or more communication interfaces 426 that may have different physical interfaces. Such communication interfaces may comprise interfaces for wired and wireless local area networks, for broadband wireless networks, as well as personal area networks. Some applications of the methods for generating, displaying, and using the GUI disclosed herein may comprise receiving ordered datasets over the physical interface or be generated by the machine itself by processor 402 analyzing data stored in storage device 414 or RAM 410. Further, information handling system 114 receives inputs from a user via user interface components 504 and executes appropriate functions, such as browsing functions by interpreting these inputs using processor 402.

In examples, information handling system 114 may also comprise tangible and/or non-transitory computer-readable storage devices for carrying or having computer-executable instructions or data structures stored thereon. Such tangible computer-readable storage devices may be any available device that may be accessed by a general purpose or special purpose computer, including the functional design of any special purpose processor as described above. By way of example, and not limitation, such tangible computer-readable devices may comprise RAM, ROM, EEPROM, CD-ROM or other optical disk storage, magnetic disk storage or other magnetic storage devices, or any other device which may be used to carry or store program code in the form of computer-executable instructions, data structures, or processor chip design. When information or instructions are provided via a network, or another communications connection (either hardwired, wireless, or combination thereof), to a computer, the computer properly views the connection as a computer-readable medium. Thus, any such connection is properly termed a computer-readable medium. Combinations of the above should also be comprised within the scope of the computer-readable storage devices.

Computer-executable instructions comprise, for example, instructions and data which cause a general-purpose computer, special purpose computer, or special purpose processing device to perform a certain function or group of functions. Computer-executable instructions also comprise program modules that are executed by computers in stand-alone or network environments. Generally, program modules comprise routines, programs, components, data structures, objects, and the functions inherent in the design of special-purpose processors, etc. that perform particular tasks or implement particular abstract data types. Computer-executable instructions, associated data structures, and program modules represent examples of the program code for executing steps of the methods disclosed herein. The particular sequence of such executable instructions or associated data structures represents examples of corresponding acts for implementing the functions described in such steps.

In additional examples, methods may be practiced in network computing environments with many types of computer system configurations, including personal computers, hand-held devices, multi-processor systems, microprocessor-based or programmable consumer electronics, network PCs, minicomputers, mainframe computers, and the like. Examples may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

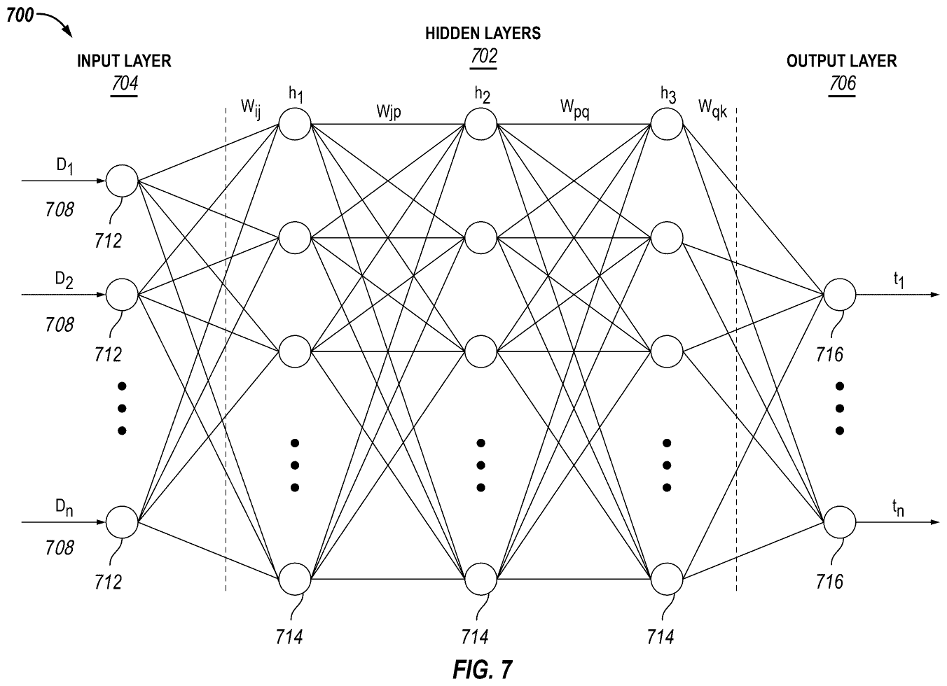

FIG. 6 illustrates an example of one arrangement of resources in a computing network 600 that may employ the processes and techniques described herein, although many others are of course possible. As noted above, an information handling system 114, as part of their function, may utilize data, which comprises files, directories, metadata (e.g., access control list (ACLS) creation/edit dates associated with the data, etc.), and other data objects. The data on the information handling system 114 is typically a primary copy (e.g., a production copy). During a copy, backup, archive or other storage operation, information handling system 114 may send a copy of some data objects (or some components thereof) to a secondary storage computing device 604 by utilizing one or more data agents 602.

A data agent 602 may be a desktop application, website application, or any software-based application that is run on information handling system 114. As illustrated, information handling system 114 may be disposed at any rig site (e.g., referring to FIG. 1), off site location, or repair and manufacturing center. The data agent may communicate with a secondary storage computing device 604 using communication protocol 608 in a wired or wireless system. Communication protocol 608 may function and operate as an input to a website application. In the website application, field data related to pre- and post-operations, generated DTCs, notes, and the like may be uploaded. Additionally, information handling system 114 may utilize communication protocol 608 to access processed measurements, operations with similar DTCs, troubleshooting findings, historical run data, and/or the like. This information is accessed from secondary storage computing device 604 by data agent 602, which is loaded on information handling system 114.

Secondary storage computing device 604 may operate and function to create secondary copies of primary data objects (or some components thereof) in various cloud storage sites 606A-N. Additionally, secondary storage computing device 604 may run determinative algorithms on data uploaded from one or more information handling systems 114, discussed further below. Communications between the secondary storage computing devices 604 and cloud storage sites 606A-N may utilize REST protocols (Representational state transfer interfaces) that satisfy basic C/R/U/D semantics (Create/Read/Update/Delete semantics), or other hypertext transfer protocol (“HTTP”)-based or file-transfer protocol (“FTP”)-based protocols (e.g., Simple Object Access Protocol).

In conjunction with creating secondary copies in cloud storage sites 606A-N, the secondary storage computing device 604 may also perform local content indexing and/or local object-level, sub-object-level or block-level deduplication when performing storage operations involving various cloud storage sites 606A-N. Cloud storage sites 606A-N may further record and maintain, EM logs, map DTC codes, store repair and maintenance data, store operational data, and/or provide outputs from determinative algorithms that are located in cloud storage sites 606A-N. In a non-limiting example, this type of network may be utilized as a platform to store, backup, analyze, import, preform extract, transform and load (“ETL”) processes, mathematically process, apply machine learning models, and augment EM measurement data sets.

A machine learning model may be an empirically derived model which may result from a machine learning algorithm identifying one or more underlying relationships within a dataset. In comparison to a physics-based model, such as Maxwell's Equations, which are derived from first principles and define the mathematical relationship of a system, a pure machine learning model may not be derived from first principles. Once a machine learning model is developed, it may be queried in order to predict one or more outcomes for a given set of inputs. The type of input data used to query the model to create the prediction may correlate both in category and type to the dataset from which the model was developed.

The structure of, and the data contained within a dataset provided to a machine learning algorithm may vary depending on the intended function of the resulting machine learning model. The rows of data, or data points, within a dataset may contain one or more independent values. Additionally, datasets may contain corresponding dependent values. The independent values of a dataset may be referred to as “features,” and a collection of features may be referred to as a “feature space.” If dependent values are available in a dataset, they may be referred to as outcomes or “target values.” Although dependent values may be a component of a dataset for certain algorithms, not all algorithms require a dataset with dependent values. Furthermore, both the independent and dependent values of the dataset may comprise either numerical or categorical values.

While it may be true that machine learning model development is more successful with a larger dataset, it may also be the case that the whole dataset isn't used to train the model. A test dataset may be a portion of the original dataset which is not presented to the algorithm for model training purposes. Instead, the test dataset may be used for what may be known as “model validation,” which may be a mathematical evaluation of how successfully a machine learning algorithm has learned and incorporated the underlying relationships within the original dataset into a machine learning model. This may comprise evaluating model performance according to whether the model is over-fit or under-fit. As it may be assumed that all datasets contain some level of error, it may be important to evaluate and optimize the model performance and associated model fit by a model validation. In general, the variability in model fit (e.g.: whether a model is over-fit or under-fit) may be described by the “bias-variance trade-off.” As an example, a model with high bias may be an under-fit model, where the developed model is over-simplified, and has either not fully learned the relationships within the dataset or has over-generalized the underlying relationships. A model with high variance may be an over-fit model which has overlearned about non-generalizable relationships within training dataset which may not be present in the test dataset. In a non-limiting example, these non-generalizable relationships may be driven by factors such as intrinsic error, data heterogeneity, and the presence of outliers within the dataset. The selected ratio of training data to test data may vary based on multiple factors, including, in a non-limiting example, the homogeneity of the dataset, the size of the dataset, the type of algorithm used, and the objective of the model. The ratio of training data to test data may also be determined by the validation method used, wherein some non-limiting examples of validation methods comprise k-fold cross-validation, stratified k-fold cross-validation, bootstrapping, leave-one-out cross-validation, resubstituting, random subsampling, and percentage hold-out.

In addition to the parameters that exist within the dataset, such as the independent and dependent variables, machine learning algorithms may also utilize parameters referred to as “hyperparameters.” Each algorithm may have an intrinsic set of hyperparameters which guide what and how an algorithm learns about the training dataset by providing limitations or operational boundaries to the underlying mathematical workflows on which the algorithm functions. Furthermore, hyperparameters may be classified as either model hyperparameters or algorithm parameters.

Model hyperparameters may guide the level of nuance with which an algorithm learns about a training dataset, and as such model hyperparameters may also impact the performance or accuracy of the model that is ultimately generated. Modifying or tuning the model hyperparameters of an algorithm may result in the generation of substantially different models for a given training dataset. In some cases, the model hyperparameters selected for the algorithm may result in the development of an over-fit or under-fit model. As such, the level to which an algorithm may learn the underlying relationships within a dataset, including the intrinsic error, may be controlled to an extent by tuning the model hyperparameters.

Model hyperparameter selection may be optimized by identifying a set of hyperparameters which minimize a predefined loss function. An example of a loss function for a supervised regression algorithm may comprise the model error, wherein the optimal set of hyperparameters correlates to a model which produces the lowest difference between the predictions developed by the produced model and the dependent values in the dataset. In addition to model hyperparameters, algorithm hyperparameters may also control the learning process of an algorithm, however algorithm hyperparameters may not influence the model performance. Algorithm hyperparameters may be used to control the speed and quality of the machine learning process. As such, algorithm hyperparameters may affect the computational intensity associated with developing a model from a specific dataset.

Machine learning algorithms, which may be capable of capturing the underlying relationships within a dataset, may be broken into different categories. One such category may comprise whether the machine learning algorithm functions using supervised, unsupervised, semi-supervised, or reinforcement learning. The objective of a supervised learning algorithm may be to determine one or more dependent variables based on their relationship to one or more independent variables. Supervised learning algorithms are named as such because the dataset comprises both independent and corresponding dependent values where the dependent value may be thought of as “the answer,” that the model is seeking to predict from the underlying relationships in the dataset. As such, the objective of a model developed from a supervised learning algorithm may be to predict the outcome of one or more scenarios which do not yet have a known outcome. Supervised learning algorithms may be further divided according to their function as classification and regression algorithms. When the dependent variable is a label or a categorical value, the algorithm may be referred to as a classification algorithm. When the dependent variable is a continuous numerical value, the algorithm may be a regression algorithm. In a non-limiting example, algorithms utilized for supervised learning may comprise Neural Networks, K-Nearest Neighbors, Naïve Bayes, Decision Trees, Classification Trees, Regression Trees, Random Forests, Linear Regression, Support Vector Machines (SVM), Gradient Boosting Regression, and Perception Back-Propagation.

The objective of unsupervised machine learning may be to identify similarities and/or differences between the data points within the dataset which may allow the dataset to be divided into groups or clusters without the benefit of knowing which group or cluster the data may belong to. Datasets utilized in unsupervised learning may not comprise a dependent variable as the intended function of this type of algorithm is to identify one or more groupings or clusters within a dataset. In a non-limiting example, algorithms which may be utilized for unsupervised machine learning may comprise K-means clustering, K-means classification, Fuzzy C-Means, Gaussian Mixture, Hidden Markov Model, Neural Networks, and Hierarchical algorithms.

In examples to determine a relationship using machine learning, a neural network (NN) 700, as illustrated in FIG. 7, may be utilized to determine efficiency of treatment fluid within the wellbore, discussed below. FIG. 7 illustrates neural network (NN) 700. NN 700 may operate utilizing one or more information handling systems 114 (e.g., referring to FIG. 1) on computing NN 700. Although a NN is illustrated, multiple models may be used with input output structures. These models may comprise flexible empirical models such as NN, gaussian processing methods, kriging methods, evolutionary methods such as genetic algorithms, classification methods, clustering methods empirical methods, or physics-based methods such as equations of state, thermodynamic models, geological, geochemistry, or chemistry models, or kinetic models or any combinations therein including recursive combinations of similar or dissimilar models and iterative model combinations. A NN 700 is an artificial neural network with one or more hidden layers 702 between input layer 704 and output layer 706. In examples, NN 700 may be software on a single information handling system 114. In other examples, NN 700 may software running on multiple information handling systems 114 connected wirelessly and/or by a hard-wired connection in a network of multiple information handling systems 114. Herein, NN 700 may be applied in a wide array of implementations.

During operations, inputs 708 data are given to neurons 712 in input layer 704. Neurons 712, 714, and 716 are defined as individual or multiple information handling systems 114 connected in a computing NN 700. The output from neurons 712 may be transferred to one or more neurons 714 within one or more hidden layers 702. Hidden layers 702 comprises one or more neurons 714 connected in a network that further process information from neurons 712. The number of hidden layers 702 and neurons 712 in hidden layer 702 may be determined by personnel that designs NN 700. Hidden layers 702 is defined as a set of information handling systems 114 assigned to specific processing. Hidden layers 702 spread computation to multiple neurons 712, which may allow for faster computing, processing, training, and learning by NN 700. Output from NN 700 may be computed by neurons 716. An information handling system 114 (e.g., referring to FIG. 1) being utilized in a computing NN 700, or alone may control operations described above 100. Specifically, measurements from operations may be utilized to maximize the use of treatment fluids in the wellbore.

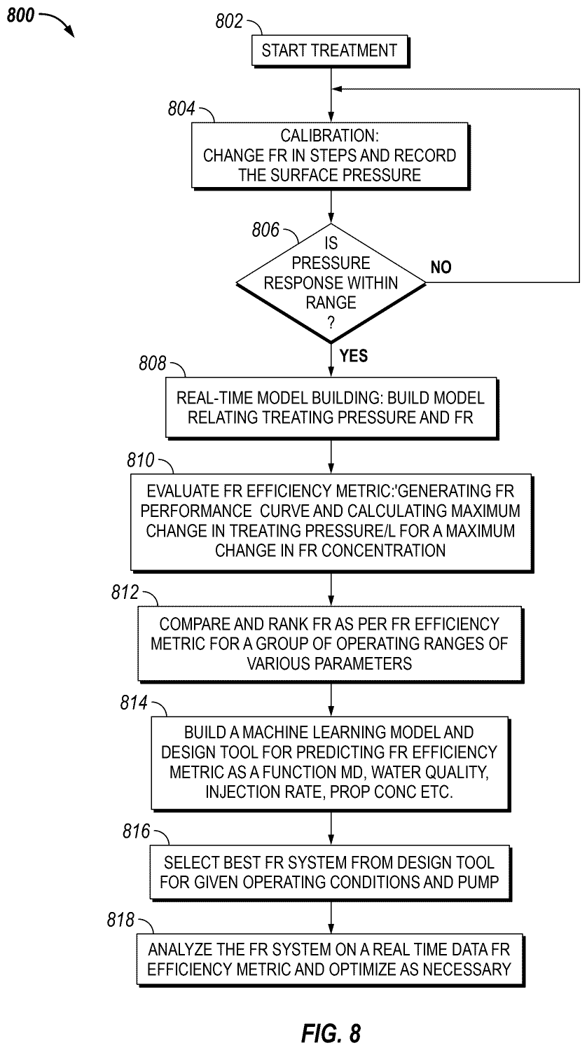

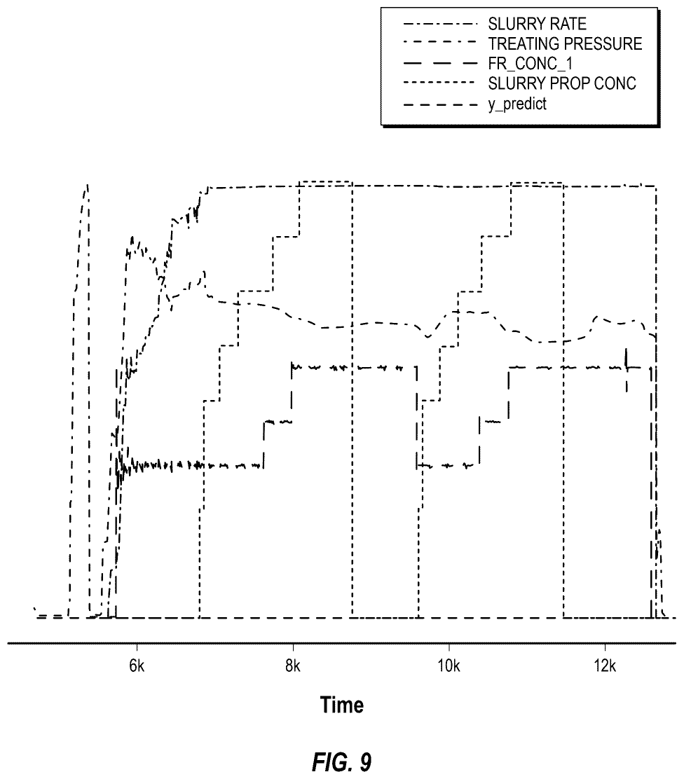

FIG. 8 illustrates a workflow 800 for selecting a treatment fluid to be used in a downhole operation. It should be noted that workflow 800 may be at least in part performed on information handling system 114. Workflow 800 may begin with block 802. Block 802 is the start of the hydraulic fracturing fluid treatment, wherein a range of the surface treating pressure is chosen to perform the multistage hydraulic fracturing job in a safe manner and minimize the energy needed to pump the hydraulic fracturing fluid treatment and therefore minimize carbon dioxide emission. The first stage of the multistage hydraulic fracturing job is the calibration stage 804, which is shown in detail in FIG. 9, wherein the surface treating pressure (noted as “TreatingPressure” in FIG. 9) is recorded as the concentration of the treatment fluid, such as a friction reducer (noted as “FR_conc_1” in FIG. 9), is changed systematically. After each change of concentration of treatment fluid, the surface treating pressure is recorded and compared to the chosen surface treating pressure range.

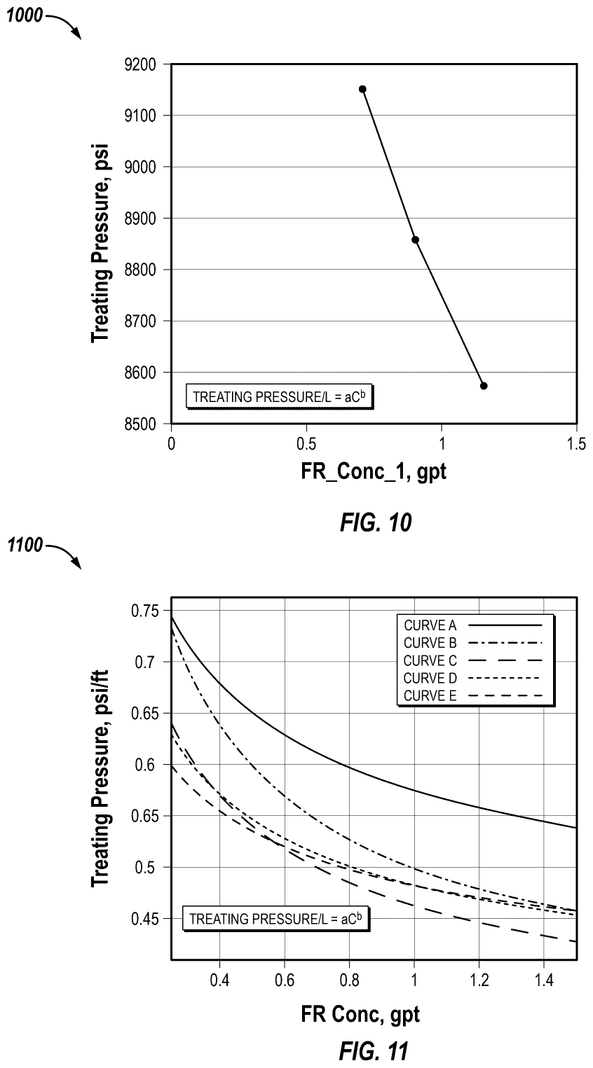

If the surface treating pressure response is not within the chosen surface treating pressure range, the concentration of friction reducer is changed further as indicated in block 806. It should be noted that the concentration may be increased or decreased for a minimum of two set points depending upon the response of the surface treating pressure and the chosen pressure range. Referring to FIG. 10, an example embodiment 1000 of the surface treating pressure recorded in psi as a function of the concentration of the treatment fluid in gallon per thousand gallons. In every concentration change step, the surface treating pressure is recorded after one wellbore volume of stimulation fluid is pumped as shown in FIG. 10. In embodiments, the final pressure may be adjusted for other processes including hydrostatic changes due to the density change, erosion, or screen-out, for example. When the change of surface treating pressure due to the change of concentration of the treatment fluid is within the chosen surface treating pressure range, real-time model building starts at block 808, referring now to FIG. 8.

In block 808, one or more models may be built relating surface treating pressure to treatment fluid. The process of adjusting the surface treating pressure due to the hydrostatic pressure change may include adding hydrostatic pressure contribution to surface treating pressure. The hydrostatic pressure can be estimated as,

$${P}_{hyd} = ρ gH \qquad Equation ( 1 )$$

where ρ is the fluid density, g is gravitational acceleration, and H is vertical height of treatment interval from surface.

In another example, the treating pressure may be adjusted to account for frictional pressure difference due to change in measure depth e.g. Pₛ/L, where Pₛ is the surface treating pressure and L is the measured depth from surface.

The process of correcting the surface treating pressure due to erosion may include change accounting for diameter changes e.g.

$$\frac{dD}{dt} = α {Cv}^{2} \qquad Equation ( 2 )$$

$$\frac{{dC}_{d}}{dt} = β {Cv}^{2} ( 1 - \frac{{C}_{d}}{{C}_{d}^{max}} ) \qquad Equation ( 3 )$$

where, C_{d} is discharge coefficient, α, β are fitting coefficients, ν is velocity, D is a perforation diameter, and C is proppant or sand concentration.

Another process for correcting the surface treating pressure when a model for the underlying process is unavailable is obtaining the slope of the surface pressure defined as rate of change of treating pressure with respect to time, at the start of the change in friction reducer concentration. By knowing the time of the end of friction reducer concentration change, and by assuming the underlying process present at the start remains the same, the contribution from those effects can be eliminated by using the slope measured and knowing the time window of the friction reducer concentration change.

In embodiments, the time gap between surface treating pressure measurements is greater than wellbore sweep time.

In some embodiments, a semi-empirical relationship is built between the surface treating pressure and the concentration of the treatment fluid with fitting constants a and b as shown in FIG. 10, wherein the surface treating pressure divided by the distance/in feet from surface to the depth at which fracking is performed is related to the concentration of the treatment fluid C corrected by constants a and b as modeled by Equation (4):

$$\frac{( {P}_{s} + {P}_{hyd} )}{L} = {aC}^{b} \qquad Equation ( 4 )$$

In a more general form, the relationship can be represented by
Pressure=f (concentration) where the pressure term on the left side of Equation (4) can be measured or adjusted surface treating pressure or any other response variable needed to decode the impact of change in treatment fluid concentration of interest e.g. Friction reducer concentration.

Equation (4) in FIG. 10 provides a method of evaluating the performance of the treatment fluid during the calibration stage. Further, a and b depend upon the type of friction reducer, quality of the water used in the treatment fluid being pumped, proppant concentration, internal diameter of wellbore, length of the tubing, stability of the treatment fluid, shear rate the treatment fluid is exposed to, Reynold number, and completion of the well, e.g. number of perforations, perforation diameter, for example.

This relationship of surface treating pressure per unit length of treatment interval from surface as a function of concentration of treatment fluid may be generated for different pumping rate or injection rate of the fracturing fluid, proppant concentrations, length of the tubing, stability of the treatment fluid, internal diameter of the tubing, for example. These relationships may form a family of curves for one type of friction reducer as shown in FIG. 11, wherein the surface treating pressure per unit length of treatment interval from surface is plotted as a function of concentration of friction reducers generated from calibration done on treatment treatments of different wells. These curves may also be called performance or characteristic curves of treatment fluids under application of the corresponding treatment. Apart from obvious changes in measured depth of treatments from the surface, FIG. 11 shows performance curves for different treatment fluid types 1100. The performance curves with the same type of fluid may vary with their manufacturing batch. The water quality used on each of these treatments may vary depending on the conditions onsite. The difference in performance curve can be because of above reasons as well as due to difference in entry friction downhole even if the initial completion types may be the same.

Referring back to FIG. 8, block 810 comprises the evaluation of the treatment fluid efficiency using a treatment fluid efficiency metric. Evaluation of treatment fluid efficiency metric comprises the performance curve of treatment fluid from FIG. 11 wherein the maximum difference of surface treating pressure or any other response variable is calculated for a maximum change in treatment fluid concentration, i.e. friction reducer concentration change of interest. Alternatively, by using the relationship between surface treating pressure and treatment fluid concentration from Equation 4, the treatment fluid efficiency metric i.e. maximum change in surface treating pressure (per unit length of treatment interval from surface) for a given change in treatment fluid concentration is evaluated by Equation (5) as follows:

$${\begin{matrix}Maximum change in \\ response variable or\end{matrix} [ Δ ( \frac{( {P}_{s} + {P}_{hyd} )}{L} ) ]}_{max} = {( \frac{( {P}_{s} + {P}_{hyd} )}{L} )}_{@ Min fluid or FR concentration} - {( \frac{( {P}_{s} + {P}_{hyd} )}{L} )}_{@ Max fluid or FR concentration} \qquad Equation ( 5 )$$

Alternatively, using the relationship of Equation (4), the fluid efficiency metric, i.e. the maximum change in surface treating pressure per unit length of treatment interval from surface, may also be normalized by dividing it using the maximum treatment change in treatment fluid concentration of interest.

$$\begin{matrix}Maximum change in response variable per \\ unit maximum change in fluid concentration\end{matrix} = \frac{\begin{matrix}{( \frac{( {P}_{s} + {P}_{hyd} )}{L} )}_{@ Min fluid or FR concentration} - \\ {( \frac{( {P}_{s} + {P}_{hyd} )}{L} )}_{@ Max fluid or FR concentration}\end{matrix}}{\begin{matrix}Max fluid or FR concentration - \\ Min fluid or FR concetration\end{matrix}} \qquad Equation ( 6 )$$

In block 812 (referring to FIG. 8), the treatment fluids may be compared and ranked per fluid efficiency or friction reducer efficiency metric. The treatment fluid efficiency metric provides a method for comparing the treatment fluid performance as a function of measured depth by normalizing the concentration of the treatment fluid under consideration and separating the effect of different surface treating pressures observed in different fluid treatment conditions including temperature, pressure, shear rate, and stresses, for example. The treatment fluids may be compared based on fluid efficiency or friction reducer efficiency metric based on the different operating conditions of interest for example water total dissolved solids, various ion concentrations, measured depth, injection rate, vertical depth, stresses, perforation count, casing internal diameter, perforation diameter, proppant concentration, proppant size and shape, etc.

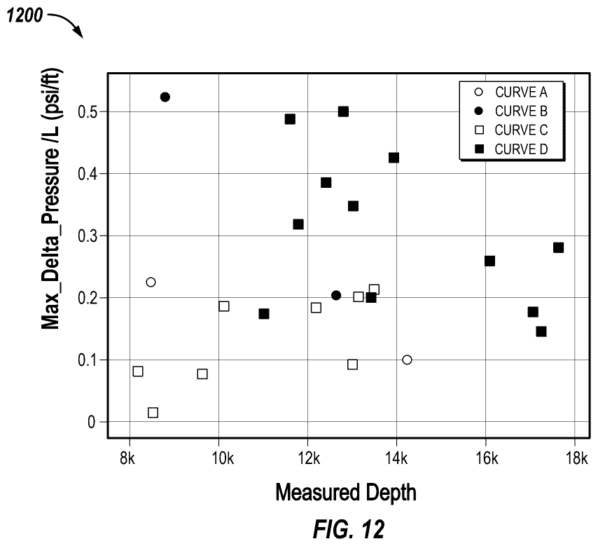

In FIG. 12, different types of treatment fluids are evaluated and compared using fluid efficiency metric 1200 defined by Equation (5) above. A friction reducer corresponding to the dots labelled D shows the highest efficiency at a measured depth of 12,614 ft, for example. Further, friction reducer D appears to provide better performance than A, B, and C. Therefore, the friction reducer efficiency and performance may be compared and ranked in real time during the multistage fracturing job for group of operating conditions or ranges of various parameters. Thus, an operator may choose one type of friction reducer for one or more toe stages and another type of friction reducer for one or more heel stages to get optimal performance and cost for a given multistage fracturing job, for example.

In block 814 of FIG. 8, a machine learning model is built for predicting friction reducer efficiency metric as a function of measured depth, water quality, injection rate, proppant concentration, entry friction, perforation diameter, perforation count, wellbore diameter, vertical depth, for example. This may provide a much quicker way of selecting friction reducer for specific operating conditions in block 816. The machine learning model may comprise a neural network model. The input data comprises the friction reducer concentration range, friction reducer type, temperature, fluid/friction reducer type, measured depth, water total dissolved solids, various ion concentrations, injection rate, proppant concentration, entry friction, perforation diameter, perforation count, wellbore diameter, vertical depth, proppant type, size and shape, for example. The output of the neutral network may be the fluid efficiency metric. In another example the machine learning model may be anything described in the section above along with the training methodology discussed therein.

Finally, the data acquired with the selected friction reducer is analyzed in real time and correction or optimization may be performed if necessary in block 818. The correction or optimization in block 818 include change of type of friction reducer, concentration of friction reducer, pumping rate of the hydraulic fracturing treatment, water type, concentration of proppant, type and concentration of any one of the other components of the hydraulic fracturing treatment, or any combination thereof.

The treatment fluids may be pumped at different additive concentrations according to embodiments of the present disclosure. For example, the treatment fluids may be pumped into one or more wellbores at an additive or friction reducer concentration of about 0.1 gallons per thousand gallons clean fluid (gpt) to about 40 gallons per thousand gallons of clean fluid. Alternatively, from about 0.1 gallons per thousand gallons clean fluid to about 20 gallons per thousand gallons clean fluid, about 0.25 gallons per thousand gallons clean fluid to about 10 gallons per thousand gallons clean fluid, about 0.5 gallons per thousand gallons clean fluid to about 10 gallons per thousand gallons clean fluid, about 0.5 gallons per thousand gallons clean fluid to about 5 gallons per thousand gallons clean fluid, about 0.5 gallons per thousand gallons clean fluid to about 2.5 gallons per thousand gallons clean fluid, or any ranges therebetween. For the Calibration step further described below, the change in additive concentrations i.e. step magnitude can be of the range of 0.1 gallons per thousand gallons of clean fluid to 5 gallons per thousand gallons of clean fluid. Alternatively, from 0.25 gallons per thousand gallons to 2.5 gallons per thousand gallons of clean fluid, about 0.5 gallons per thousand gallons of clean fluid to 1 gallons per thousand gallons of clean fluid. The corresponding change in surface treating pressures from 0 to 5000 psi. Alternatively, from about 20 psi to about 2500 psi, about 0.50 psi to about 1500 psi, about 100 psi to about 1000 psi or any ranges therebetween. Note that the treating pressure change may be positive or negative depending upon whether the additive concentration is increasing or decreasing in steps.

The range for fluid efficiency metric may be from 0 to 20 psi/ft change in treating pressure for a given change of friction reducer or treating fluid concentration of interest. Alternatively, from about 0.05 psi/ft to about 10 psi/ft, about 0.1 psi/ft to about 5 psi/ft, about 0.25 psi/ft to about 1 psi/ft or any ranges there between. Alternatively, the range for fluid efficiency metric may be from 0 to 200 psi/ft per unit change in friction reducer or additive concentration. Alternatively, from about 0.01 psi/ft per unit change in friction reducer or additive concentration to about 100 psi/ft per unit change in friction reducer, about 0.05 psi/ft per unit change in friction reducer or additive concentration to about 50 psi/ft per unit change in friction reducer or additive concentration, about 0.1 psi/ft per unit change in friction reducer or additive concentration to about 5 psi/ft per unit change in friction reducer or additive concentration or any ranges there between.

In embodiments, additive concentration may also be in the range of about 0.1 pounds per thousand gallons clean fluid to about 50 pounds per thousand gallons of clean fluid. Alternatively, from about 0.1 pounds per thousand gallons clean fluid to about 20 pounds per thousand gallons clean fluid, about 0.25 pounds per thousand gallons clean fluid to about 10 pounds per thousand gallons clean fluid, about 0.5 pounds per thousand gallons clean fluid to about 10 pounds per thousand gallons clean fluid, about 0.5 pounds per thousand gallons clean fluid to about 5 pounds per thousand gallons clean fluid, about 0.5 pounds per thousand gallons clean fluid to about 2.5 gallons per thousand gallons clean fluid, or any ranges therebetween. For the Calibration step the change in additive concentrations i.e. step magnitude can be of the range of 0.1 pounds per thousand gallons of clean fluid to 5 pounds per thousand gallons of clean fluid. Alternatively, from 0.25 pounds per thousand gallons to 2.5 pounds per thousand gallons of clean fluid, about 0.5 pounds per thousand gallons of clean fluid to 1 pounds per thousand gallons of clean fluid. The corresponding change in surface treating pressures from 0 to 5000 psi. Alternatively, from about 20 psi to about 2500 psi, about 0.50 psi to about 1500 psi, about 100 psi to about 1000 psi or any ranges therebetween. Note that the treating pressure change may be positive or negative depending upon whether the additive concertation is increasing or decreasing in steps.

Accordingly, the present disclosure may provide treatment fluids and methods of selecting friction reducers for treatment fluids.

This disclosure describes a technique that is robust and reliable as it has been evolving directly from the field data. It strongly overcomes limitations such as low shear rates in laboratory environment as compared to extreme high shear rates experienced in the field or need for any laboratory experiments to characterize and compare fluid performances.

As opposed to conventional techniques, embodiments of the present disclosure do not need any bottom hole gauges to evaluate and compare the friction reducers performances reducing the cost of evaluation. In embodiments, real time calibration and evaluation of the fluids, i.e. on the fly; result in the ability to decide and optimize the treatment in real time by adjusting the fluids concentrations or changing the fluid types.

A characteristic curve and single fluid efficiency metric may compare any number of fluids without the need to know its chemical constituents including the structure property relationships, for example.

In embodiments, the calibration may be repeated any number of times within the same treatment or on multiple treatments on the same well. The real time calibration technique may be used for any fluid types that have a different function in subterranean treatments e.g. one can calibrate acid fluid performance in real time in matrix acidizing treatments or scale or hydrate removal, for example.

Statement 1. A method comprising: setting a surface treating pressure range for a first stage of a multistage fracturing job; introducing a treatment fluid into a wellbore extending into a subterranean formation, wherein the treatment fluid comprises: water; an acid; a corrosion inhibitor; and a friction reducer; measuring a surface treating pressure; changing a concentration of the friction reducer to have at least two surface treating pressure measurements within the surface treating pressure range; establishing a relationship between the surface treating pressure measurements and the concentrations of the friction reducer; evaluating a treatment fluid performance metric based on the relationship between the surface treating pressure measurements and the concentrations of the friction reducer; and selecting the concentration of the friction reducer for a second stage of the multistage fracturing job based at least in part on the treatment fluid performance metric.

Statement 2. The method of Statement 1, wherein the relationship between the surface treating pressure measurements and the concentrations of the friction reducer is a semi-empirical equation as follows:

$$\frac{( {P}_{s} + {P}_{hyd} )}{L} = {aC}^{b}$$

where Pₛ is surface treating pressure, P_{hyd} is hydrostatic pressure, L is measured depth from surface, a is a fitting coefficients, and C is proppant or sand concentration.

Statement 3. The method of Statement 1 or Statement 2, wherein evaluating the treatment fluid performance metric comprises a friction reducer efficiency metric comprising a maximum change in surface treating pressure per unit of length of treatment interval from surface for a specified change of concentration of the friction reducer.

Statement 4. The method of any one of Statements 1-3, wherein the evaluating the treatment fluid performance metric is performed using a treatment fluid efficiency metric evaluated as follows:

$$Maximum change in surface treating pressure {or [ Δ ( \frac{( {P}_{s} + {P}_{hyd} )}{L} ) ]}_{max} = {( \frac{( {P}_{s} + {P}_{hyd} )}{L} )}_{@ Min fluid or FR concentration} - {( \frac{( {P}_{s} + {P}_{hyd} )}{L} )}_{@ Max fluid or FR concentration}$$

where Pₛ is surface treating pressure, P_{hyd} is hydrostatic pressure, L is measured depth from surface, and FR is friction reducer.

Statement 5. The method of any one of Statements 1-4, wherein the evaluating the treatment fluid performance metric is performed using a normalized treatment fluid efficiency metric evaluated as follows:

$$\begin{matrix}Maximum change in surface treating response per \\ unit maximum change in fluid concentration\end{matrix} = \frac{\begin{matrix}{( \frac{( {P}_{s} + {P}_{hyd} )}{L} )}_{@ Min fluid or FR concentration} - \\ {( \frac{( {P}_{s} + {P}_{hyd} )}{L} )}_{@ Max fluid or FR concentration}\end{matrix}}{\begin{matrix}Max fluid or FR concentration - \\ Min fluid or FR concentration\end{matrix}}$$

where Pₛ is surface treating pressure, P_{hyd} is hydrostatic pressure, L is measured depth from surface, and FR is friction reducer.

Statement 6. The method of any one of Statements 1-5, wherein a final surface treating pressure is corrected for operation processes using hydrostatic pressure using a hydrostatic pressure P_{hyd} as follows:

$${P}_{hyd} = ρ gH$$

where p is a fluid density, g is gravitational acceleration, and His vertical height of treatment interval from surface.

Statement 7. The method of any one of Statements 1-6, further comprises updating at least in part the surface treating pressure for operation processes using a slope between the surface treating pressure measurements and a time difference between the surface treating pressure measurements.

Statement 8. The method of any one of Statements 1-7, wherein the surface treating pressure measurements are corrected for erosion of an internal diameter of a completion using an equation as follows:

$$\frac{dD}{dt} = α {Cv}^{2}$$

where α is a fitting coefficient, vis velocity, D is a perforation diameter, and C is proppant or sand concentration.

Statement 9. The method of any one of Statements 1-8, wherein a time gap between surface treating pressure measurements is greater than a wellbore sweep time.

Statement 10. The method of any one of Statements 1-9, wherein the treatment fluid performance metric is evaluated and ranked by comparing the treatment fluid performance metric to at least another treatment fluid performance metric evaluated in at least one different well or another stage of a same well for a given set of operating conditions comprising water total dissolved solids, various ion concentrations, measured depth from surface, injection rate, vertical depth, stresses, perforation count, casing internal diameter, perforation diameter, proppant concentration, proppant size and shape, and any combination thereof.

Statement 11. The method of any one of Statements 1-10, further selecting a treatment fluid with the best efficiency by predicting the treatment fluid performance metric as a function of water total dissolved solids, various ion concentrations, measured depth from surface, injection rate, vertical depth, stresses, perforation count, casing internal diameter, perforation diameter, proppant concentration, proppant size and shape, in real time.

Statement 12. The method of any one of Statements 1-11, further selecting a treatment fluid with the best efficiency at a given operating condition comprising quality of the water, proppant concentration, internal diameter of the wellbore, length of a tubing, stability of the treatment fluid, shear rate the treatment fluid is exposed to, Reynold number, and completion of a well.

Statement 13. The method of any one of Statements 1-12, wherein the evaluating the treatment fluid performance metric is performed in real time.

Statement 14. The method of any one of Statements 1-13, wherein establishing the relationship between the surface treating pressure measurements and the concentrations of the friction reducer is repeated on multiple stages of a well.

Statement 15. One or more non-transitory readable media including instructions executable by a processor, the instructions comprising: instructions to set a surface treating pressure range for a first stage of a multistage fracturing job; instructions to introduce a treatment fluid into a wellbore extending into a subterranean formation, wherein the treatment fluid comprises: water; an acid; a corrosion inhibitor; and a friction reducer; instructions to measure a surface treating pressure; instructions to change a concentration of the friction reducer to have at least two surface treating pressure measurements within the surface treating pressure range; instructions to establish a relationship between the surface treating pressure measurements and the concentrations of the friction reducer; instructions to evaluate a treatment fluid performance metric based on the relationship between the surface treating pressure measurements and the concentrations of the friction reducer; and instructions to select the concentration of the friction reducer for a second stage of the multistage fracturing job based at least in part on the treatment fluid performance metric.

Statement 16. The machine-readable media of Statement 15, wherein the instructions to establish a relationship between the surface treating pressure measurements and the concentrations of the friction reducer is a semi-empirical equation as follows:

$$\frac{( {P}_{s} + {P}_{hyd} )}{L} = {aC}^{b}$$

where Pₛ is surface treating pressure, P_{hyd} is hydrostatic pressure, L is measured depth from surface, α is a fitting coefficients, and C is proppant or sand concentration.

Statement 17. The machine-readable media of Statement 15 or Statement 16, wherein the instructions to evaluate the treatment fluid performance metric comprise a friction reducer efficiency metric comprising a maximum change in surface treating pressure per unit of length of treatment interval from surface for a specified change of concentration of the friction reducer.

Statement 18. The machine-readable media of any one of Statements 15-17, wherein the instructions to evaluate the treatment fluid performance metric are performed using a treatment fluid efficiency metric evaluated as follows:

$${\begin{matrix}Maximum change in surface \\ treating pressure or\end{matrix} [ Δ ( \frac{( {P}_{s} + {P}_{hyd} )}{L} ) ]}_{max} = {( \frac{( {P}_{s} + {P}_{hyd} )}{L} )}_{@ Min fluid or FR concentration} - {( \frac{( {P}_{s} + {P}_{hyd} )}{L} )}_{@ Max fluid or FR concentration}$$

where Pₛ is surface treating pressure, P_{hyd} is hydrostatic pressure, L is measured depth from surface, and FR is friction reducer.

Statement 19. The machine-readable media of any one of Statements 15-18, wherein the instructions to evaluate the treatment fluid performance metric are performed using a normalized treatment fluid efficiency metric evaluated as follows:

$$\begin{matrix}Maximum change in surface treating response per \\ unit maximum change in fluid concentration\end{matrix} = \frac{\begin{matrix}{( \frac{( {P}_{s} + {P}_{hyd} )}{L} )}_{@ Min fluid or FR concentration} - \\ {( \frac{( {P}_{s} + {P}_{hyd} )}{L} )}_{@ Max fluid or FR concentration}\end{matrix}}{\begin{matrix}Max fluid or FR concentration - \\ Min fluid or FR concentration\end{matrix}}$$

where Pₛ is surface treating pressure, P_{hyd} is hydrostatic pressure, L is measured depth from surface, and FR is friction reducer.

Statement 20. The machine-readable media of any one of Statements 15-19, further comprises updating at least in part the surface treating pressure for operation processes using hydrostatic pressure using a hydrostatic pressure P_{hyd} as follows:

$${P}_{hyd} = ρ gH$$

where ρ is a fluid density, g is gravitational acceleration, and H is vertical height of treatment interval from surface.

To facilitate a better understanding of the present invention, the following examples of certain aspects of some embodiments are given. In no way should the following examples be read to limit, or define, the entire scope of the disclosure.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values even if not explicitly recited. Thus, every point or individual value may serve as its own lower or upper limit combined with any other point or individual value or any other lower or upper limit, to recite a range not explicitly recited.

Therefore, the present embodiments are well adapted to attain the ends and advantages mentioned as well as those that are inherent therein. The particular embodiments disclosed above are illustrative only, as the present embodiments may be modified and practiced in different but equivalent manners apparent to those skilled in the art having the benefit of the teachings herein. Although individual embodiments are discussed, all combinations of each embodiment are contemplated and covered by the disclosure. Furthermore, no limitations are intended to the details of construction or design herein shown, other than as described in the claims below. Also, the terms in the claims have their plain, ordinary meaning unless otherwise explicitly and clearly defined by the patentee. It is therefore evident that the particular illustrative embodiments disclosed above may be altered or modified and all such variations are considered within the scope and spirit of the present disclosure.

What is claimed is:

1. A method comprising:
setting a surface treating pressure range for a first stage of a multistage fracturing job;
introducing a treatment fluid into a wellbore extending into a subterranean formation, wherein the treatment fluid comprises:
water;
an acid;
a corrosion inhibitor; and
a friction reducer;
measuring a surface treating pressure;
changing a concentration of the friction reducer to have at least two surface treating pressure measurements within the surface treating pressure range;
establishing a relationship between the surface treating pressure measurements and the concentrations of the friction reducer;
evaluating a treatment fluid performance metric based on the relationship between the surface treating pressure measurements and the concentrations of the friction reducer; and
selecting the concentration of the friction reducer for a second stage of the multistage fracturing job based at least in part on the treatment fluid performance metric.

2. The method of claim 1, wherein the relationship between the surface treating pressure measurements and the concentrations of the friction reducer is a semi-empirical equation as follows:
$$\frac{( {P}_{s} + {P}_{hyd} )}{L} = {aC}^{b}$$
where Pₛ is surface treating pressure, P_{hyd} is hydrostatic pressure, L is measured depth from surface, α is a fitting coefficients, and C is proppant or sand concentration.

3. The method of claim 1, wherein evaluating the treatment fluid performance metric comprises a friction reducer efficiency metric comprising a maximum change in surface treating pressure per unit of length of treatment interval from surface for a specified change of concentration of the friction reducer.

4. The method of claim 1, wherein the evaluating the treatment fluid performance metric is performed using a treatment fluid efficiency metric evaluated as follows:
$${\begin{matrix}Maximum change in surface \\ treating pressure or\end{matrix} [ Δ ( \frac{( {P}_{s} + {P}_{hyd} )}{L} ) ]}_{max} = {( \frac{( {P}_{s} + {P}_{hyd} )}{L} )}_{@ Min fluid or FR concentration} - {( \frac{( {P}_{s} + {P}_{hyd} )}{L} )}_{@ Max fluid or FR concentration}$$
where Pₛ is surface treating pressure, P_{hyd} is hydrostatic pressure, L is measured depth from surface, and FR is friction reducer.

5. The method of claim 1, wherein the evaluating the treatment fluid performance metric is performed using a normalized treatment fluid efficiency metric evaluated as follows:
$$\begin{matrix}Maximum change in surface treating response per \\ unit maximum change in fluid concentration\end{matrix} = \frac{\begin{matrix}{( \frac{( {P}_{s} + {P}_{hyd} )}{L} )}_{@ Min fluid or FR concentration} - \\ {( \frac{( {P}_{s} + {P}_{hyd} )}{L} )}_{@ Max fluid or FR concentration}\end{matrix}}{\begin{matrix}Max fluid or FR concentration - \\ Min fluid or FR concentration\end{matrix}}$$
where Pₛ is surface treating pressure, P_{hyd} is hydrostatic pressure, L is measured depth from surface, and FR is friction reducer.

6. The method of claim 1, wherein a final surface treating pressure is corrected for operation processes using hydrostatic pressure using a hydrostatic pressure P_{hyd} as follows:
$${P}_{hyd} = ρ gH$$
where ρ is a fluid density, g is gravitational acceleration, and H is vertical height of treatment interval from surface.

7. The method of claim 1, further comprises updating at least in part the surface treating pressure for operation processes using a slope between the surface treating pressure measurements and a time difference between the surface treating pressure measurements.

8. The method of claim 1, wherein the surface treating pressure measurements are corrected for erosion of an internal diameter of a completion using an equation as follows:
$$\frac{dD}{dt} = α {Cv}^{2}$$
where α is a fitting coefficient, vis velocity, D is a perforation diameter, and C is proppant or sand concentration.

9. The method of claim 1, wherein a time gap between surface treating pressure measurements is greater than a wellbore sweep time.

10. The method of claim 1, wherein the treatment fluid performance metric is evaluated and ranked by comparing the treatment fluid performance metric to at least another treatment fluid performance metric evaluated in at least one different well or another stage of a same well for a given set of operating conditions comprising water total dissolved solids, various ion concentrations, measured depth from surface, injection rate, vertical depth, stresses, perforation count, casing internal diameter, perforation diameter, proppant concentration, proppant size and shape, and any combination thereof.

11. The method of claim 1, further selecting a treatment fluid with the best efficiency by predicting the treatment fluid performance metric as a function of water total dissolved solids, various ion concentrations, measured depth from surface, injection rate, vertical depth, stresses, perforation count, casing internal diameter, perforation diameter, proppant concentration, proppant size and shape, in real time.

12. The method of claim 1, further selecting a treatment fluid with the best efficiency at a given operating condition comprising quality of the water, proppant concentration, internal diameter of the wellbore, length of a tubing, stability of the treatment fluid, shear rate the treatment fluid is exposed to, Reynold number, and completion of a well.

13. The method of claim 1, wherein the evaluating the treatment fluid performance metric is performed in real time.

14. The method of claim 1, wherein establishing the relationship between the surface treating pressure measurements and the concentrations of the friction reducer is repeated on multiple stages of a well.

15. One or more non-transitory machine-readable media including instructions executable by a processor, the instructions comprising:
instructions to set a surface treating pressure range for a first stage of a multistage fracturing job;
instructions to introduce a treatment fluid into a wellbore extending into a subterranean formation, wherein the treatment fluid comprises:
water;
an acid;
a corrosion inhibitor; and
a friction reducer;
instructions to measure a surface treating pressure;
instructions to change a concentration of the friction reducer to have at least two surface treating pressure measurements within the surface treating pressure range;
instructions to establish a relationship between the surface treating pressure measurements and the concentrations of the friction reducer;
instructions to evaluate a treatment fluid performance metric based on the relationship between the surface treating pressure measurements and the concentrations of the friction reducer; and
instructions to select the concentration of the friction reducer for a second stage of the multistage fracturing job based at least in part on the treatment fluid performance metric.

16. The machine-readable media of claim 15, wherein the instructions to establish a relationship between the surface treating pressure measurements and the concentrations of the friction reducer are semi-empirical equations as follows:
$$\frac{( {P}_{s} + {P}_{hyd} )}{L} = {aC}^{b}$$
where Pₛ is surface treating pressure, P_{hyd} is hydrostatic pressure, L is measured depth from surface, α is a fitting coefficients, and C is proppant or sand concentration.

17. The machine-readable media of claim 15, wherein the instructions to evaluate the treatment fluid performance metric comprise a friction reducer efficiency metric comprising a maximum change in surface treating pressure per unit of length of treatment interval from surface for a specified change of concentration of the friction reducer.

18. The machine-readable media of claim 15, wherein the instructions to evaluate the treatment fluid performance metric are performed using a treatment fluid efficiency metric evaluated as follows:
$${\begin{matrix}Maximum change in surface \\ treating pressure or\end{matrix} [ Δ ( \frac{( {P}_{s} + {P}_{hyd} )}{L} ) ]}_{max} = {( \frac{( {P}_{s} + {P}_{hyd} )}{L} )}_{@ Min fluid or FR concentration} - {( \frac{( {P}_{s} + {P}_{hyd} )}{L} )}_{@ Max fluid or FR concentration}$$
where Pₛ is surface treating pressure, P_{hyd} is hydrostatic pressure, L is measured depth from surface, and FR is friction reducer.

19. The machine-readable media of claim 15, wherein the instructions to evaluate the treatment fluid performance metric are performed using a normalized treatment fluid efficiency metric evaluated as follows:
$$\begin{matrix}Maximum change in surface treating response per \\ unit maximum change in fluid concentration\end{matrix} = \frac{\begin{matrix}{( \frac{( {P}_{s} + {P}_{hyd} )}{L} )}_{@ Min fluid or FR concentration} - \\ {( \frac{( {P}_{s} + {P}_{hyd} )}{L} )}_{@ Max fluid or FR concentration}\end{matrix}}{\begin{matrix}Max fluid or FR concentration - \\ Min fluid or FR concentration\end{matrix}}$$
where Pₛ is surface treating pressure, P_{hyd} is hydrostatic pressure, L is measured depth from surface, and FR is friction reducer.

20. The machine-readable media of claim 15, wherein the instructions further comprise updating at least in part the surface treating pressure range for operation processes using hydrostatic pressure using a hydrostatic pressure P_{hyd} as follows:
$${P}_{hyd} = ρ gH$$
where ρ is a fluid density, g is gravitational acceleration, and H is vertical height of treatment interval from surface.
